(19) United States
(12) Patent Application Publication
(10) Pub. No.: US 2020/0404543 A1
(43) Pub. Date: Dec. 24, 2020

(54) TECHNIQUE FOR CONFIGURING AN OVERLOAD FUNCTION IN A CELLULAR NETWORK

(71) Applicant: Telefonaktiebolaget LM Ericsson (publ), Stockholm (SE)

(72) Inventors: Badawi YAMINE, BEIRUT (LB); Angelo CENTONZA, STOCKHOLM (SE); Lars-Bertil OLSSON, ANGERED (SE)

(21) Appl. No.: 16/957,800

(22) PCT Filed: Mar. 16, 2018
(86) PCT No.: PCT/EP2018/056723

§ 371 Date: Jun. 25, 2020

(51) Int. Cl. H04W 28/10; H04W 28/02

(52) U.S. Cl. CPC H04W 28/10; H04W 28/0284

(57) ABSTRACT

A technique for configuring an overload function in a cellular network including a core network (CN) and a radio access network (RAN) is described. The overload function reduces a signaling load from the RAN towards the CN. The RAN includes at least one network element (NE). Each NE serves at least two cells of the RAN. As to a method aspect of the technique, a configuration message is sent to the cellular network. The configuration message is indicative of at least one of the at least two cells. The at least one indicated cell is excluded from the overload function.

### TECHNICAL FIELD

The present disclosure generally relates to an overload function in a cellular network. More specifically, methods and devices are provided for controlling or configuring an overload function in a cellular network.

### BACKGROUND

Cellular networks comprise a radio access network (RAN) providing radio access to mobile devices and a core network (CN) inter alia controlling mobility and security for the radio access at the RAN. The traffic to and from the mobile devices is taken by the RAN and routed through the CN. To ensure that the cellular network is in a stable state, a congestion control or overload function monitors, detects and handles overloaded states of the CN or when the status of the CN is reaching an overloaded state.

For example, the Third Generation Partnership Project (3GPP) has defined cellular networks for Long Term Evolution (LTE). Whenever the CN, in particular a Mobility Management Entity (MME), becomes congested, the overload function gradually blocks more and more radio base stations (RBSs) of the RAN from taking any traffic, e.g., according to the document 3GPP TS 36.413, Version 14.1.0, defining an S1. Application Protocol (S1AP) for the interface S1 between the RAN and the CN. 3GPP has also agreed that Next Generation or 5G architectures comprise a similar overload function, e.g., for protecting a Mobility Management Function (MMF) or Access and Mobility Functions (AMF), which may be considered as a 5G equivalent to the MME in LTE.

According to LTE standards, e.g., the afore-mentioned document 3GPP TS 36.413, and evolving standards for 5G at 3GPP, each time the MME or an equivalent entity is in an overload state, the entity sends a command, in particular a S1AP overload start message, to the connected RBSs ordering them to reduce or reject mobile-originated and optionally mobile-terminated data services or calls.

Such an overload start message may achieve the desired effect of reducing the traffic load for the CN if the RBS serves cells that are mainly used for less important and bandwidth-consuming services, e.g., entertainment services. However, if few cells of the RBS cover important locations such as a police station or a hospital, the achieved traffic reduction may be marginal at the cost of severe service interruptions.

### SUMMARY

Accordingly, there is a need for an overload mechanism that allows efficiently reducing traffic load in an overload situation. Alternatively or in addition, there is a need for an overload mechanism that achieves a given reduction in traffic load with less service interruptions or improved service reliability.

As to a first method aspect, a method of configuring an overload function in a cellular network comprising a core network (CN) and a radio access network (RAN) is provided. The overload function may reduce a signaling load from the RAN towards the CN. The RAN may comprise at least one network element (NE). Each of the at least one NE may serve at least two cells of the RAN. The method may comprise a step of sending a configuration message to the cellular network. The configuration message may be indicative of at least one of the at least two cells, which is excluded from the overload function.

Responsive to the configuration message, the overload function in the cellular network may be configured to exclude the at least one cell indicated in the configuration message. The overload function may reduce the signaling load of cells other than the at least one excluded cell if the CN is congested. In contrast to existing overload functions that block all cells of one or more NEs, at least some embodiments can exclude the at least one cell from the overload function, e.g., depending on a geographical location of the excluded cell. Accordingly, the overload function can be configured to efficiently and/or effectively reduce traffic load in an overload situation. The reduction may be efficient by excluding important or sensitive cells. The reduction may be effective by blocking cells that are mainly used for less important or sensitive and bandwidth-consuming services. Same or further embodiments enable an overload function that achieves a given reduction in traffic load with less service interruptions or more service reliability.

The overload function may be configured to exclude individual cells according to the configuration message. Conventionally, commands coming from the CN target the entire NE. The technique may be implemented for a cellular network comprising at least one sensitive cell as the at least one excluded cell served by the at least one NE, say NE₁. The sensitive cell may cover an important location, e.g., a police station, a hospital, etc., while one or more other cells of the NE₁ are not sensitive, e.g., because the other cells are not covering important locations. Embodiments can exclude the at least one sensitive cell of the NE₁ from the overload function so that the sensitive cell is not blocked, while the other cells may be subjected to the overload function. Thus, a reduction of the signaling load from the RAN towards the CN can be achieved with less service interruptions or minimal impact on service provision for at least some embodiments.

Embodiments can enable a congested CN to block individual cells of the at least one NE, e.g., only non-sensitive cells. For example, blindly blocking all cells of any one of the NEs in the RAN can be avoided. Alternatively or in addition, the technique may be implemented in combination with a restricted area. The restricted area may be used and/or applied by the CN, e.g., individually for each mobile device. The CN may control the service provision within the restricted are using non-access stratum (NAS) signaling.

At least some embodiments can enable controlling the overload function at the granularity of cells by means of the configuration message. Same or further embodiments may be compatible with or may improve an existing overload function by excluding the at least one cell from the overload function, e.g., by defining one or more cellular exceptions for the overload function.

The cellular network may comprise the CN and the RAN. The RAN may be connected to the CN. The RAN may comprise a plurality of NEs including the at least one NE. For example, each of the plurality of NEs of the RAN may serve at least two cells. The cellular network may encompass any Public Land Mobile Network (PLMN).

Each of the plurality of NEs of the RAN may provide radio access to one or more mobile devices. The NEs may be base stations, access points or radio heads. One or more mobile devices may be wirelessly connected to any one of the NEs. The mobile devices may be user equipments (UEs) or mobile stations.

The configuration message indicative of at least one cell may be cell-specific. Each of the at least one cell excluded from the overload function may also be referred to as an excluded cell. Any one of the at least one cell excluded from the overload function may be a sensitive cell. A cell that covers an object of a predefined class of objects may be a sensitive cell. The predefined class of objects may comprise public facilities, healthy services and/or public safety services. Public facilities may comprise any facility, including, but not limited to, buildings, property, recreation areas, and roads, which are owned, leased, or otherwise operated, or funded by a governmental body or public entity.

The overload function may trigger or comprise selectively restricting the signaling load from the RAN towards the CN. The configuration message indicative of the at least one excluded cell may define a cell-specific configuration for the restriction (e.g., a cell-specific exclusion from the restriction).

The exclusion from the overload function may be subject to a condition and/or a priority level. The configuration message may be indicative of the condition and/or the priority for the at least one cell. The at least one cell may be excluded from the restriction if and/or while the condition is fulfilled. Alternatively or in addition, the at least one cell may be excluded from the restriction if the indicated priority is below a priority threshold.

The configuration message may be indicative of less than the at least two cells as being excluded from the overload function. The configuration message may be indicative of a proper subset of the at least two cells served by the same NE. For example, the configuration message may be indicative of one of the at least two cells as being excluded from the restriction.

The overload function may depend on an overload status of the CN of the cellular network. The overload status may comprise an overloaded state and a regular state. The overload function may be enabled or initiated responsive to the overloaded state at the CN. The overload function may be disabled or released responsive to the regular state at the CN.

The overload function may reduce the signaling load from the RAN towards the CN by restricting a service of the RAN in case the overload status of the CN comprises an overloaded state. The overload function may restrict requests induced by a mobile device towards to the CN, calls originating from the mobile device and/or any non-access stratum (NAS) functions for the mobile device. The mobile device may be connected to the at least ones NE.

The overload function may indicate the overload status of the CN in a control plane to the RAN, e.g., to one or more of the at least one NE. The overload function may comprise one or more overload messages that are sent from the CN to the at least one NE. The overload messages may imply or be indicative of the overload status of the CN.

The overload function may be an interface management function at an interface between the CN and the RAN. The overload status may also be referred to as a load situation. The overload message may imply or indicate the load situation in a control plane of an S1 interface and/or an NG2 interface between the CN and the RAN.

The overload messages may comprise an overload start message. The overload start message may imply or be indicative of the overloaded state in the overload status. Alternatively or in addition, the overload start message may trigger the restriction of the service of the RAN. At least some embodiments may enable sending the overload start message in a way to keep a sensitive cell excluded from restrictions. At other cells, the restrictions may be triggered by the overload start message.

Alternatively or in addition, the overload messages may comprise an overload stop message. The overload stop message may implies or be indicative of a normal or regular state in the overload status. Alternatively or in addition, the overload stop message may release the restriction of the service of the RAN.

The configuration message may be sent to each of the at least one NE. The configuration message may exclude the at least one indicated cell of the corresponding NE from the restriction.

The configuration message may cause the at least one NE to ignore the overload message with respect to the at least one indicated cell. When the corresponding NE receives the overload message, particularly the overload start massage, the NE may apply the service restriction to all of its cells except for the at least one indicated cell. The overload message may be a conventional overload message. The overload message may be cell-unspecific, e.g., unspecific as to the at least two cells served by the same NE. Preferably, the overload message does not distinguish between the at least two cells served by the corresponding NE. The overload message may be NE-specific, e.g., an individual overload message is addressed to the corresponding NE.

The configuration message may induce a tag at the at least one NE for the at least one indicated cell. When the corresponding NE receives the overload message, particularly the overload start massage, the NE may apply the service restriction to all of its cells except for the at least one tagged cell. The tag may be a binary flag stored at the least one NE.

The CN may comprise at least one of a Mobility Management Entity (MME) and an Access and Mobility Function (AMF). The overload status may relate to at least one of the MME and the AMF. The overload message may be sent from at least one of the MME and the AMF. The MME and/or the AMF may also be referred to as a Mobility Management Function (MMF).

The configuration message may be sent to the at least one NE, e.g., within a tracking area of at least one of the MME and the AMF. Alternatively or in addition, the configuration message may be sent to the CN. For example, the configuration message may be sent to at least one of the MME and the AMF. The one or more overload messages may be cell-specific according to the at least one cell indicated in the configuration message. At least one of the overload messages may be specific depending on the at least one cell indicated in the configuration message. The configuration message may trigger one or more cell-specific overload messages. The one or more cell-specific overload messages may be sent from at least one of the MME and the AMF.

The one or more overload messages may comprise an overload start message that is specific for at least one cell not indicated in the configuration message. Alternatively or in addition, the one or more overload messages may comprise an overload stop message that is specific for at least one cell indicated in the configuration message.

The at least one NE comprises a fallback NE. The at least one excluded cell of the fallback NE may comprise a fallback cell for a sensitive cell of a sensitive NE of the RAN. The fallback NE may be configured or configurable to cover the sensitive cell if the sensitive NE fails.

For example, each sensitive cell may be associated with at least one fallback cell. The at least one NE configured to cover the sensitive cell may be referred to as the fallback NE. The fallback NE may be configured to selectively cover the sensitive cell, e.g., in the case of failure of the sensitive NE. The at least one excluded cell may further comprise the sensitive cell and/or the at least one NE may further comprise the sensitive NE, e.g., before the sensitive NE failed.

At least some embodiments can enable sending a cell-specific overload stop message to the fallback NE in case the fallback cell or the fallback NE has already received an overload start message and the sensitive cell or the sensitive NE failed, e.g., due to any software or hardware issue.

The method may further comprise a step of determining a failure of the sensitive NE. The configuration message or a further control message may comprise a control command that controls the fallback cell to cover the sensitive cell. The control command may trigger adjusting a range of the fallback cell. The control command may trigger an increase in transmission power and/or a change (e.g., an uplift) of an antenna tilt angle or directional antenna gain at the fallback NE to cover the sensitive cell.

At least some embodiments can enable both sending the configuration message triggering the cell-specific overload stop message to release the service restriction triggered by a previous overload start message and sending the control message for reconfiguring the fallback cell. The configuration message and the control message may be one message. The configuration message and/or the control message may be sent to the fallback NE. For example, the configuration message may be sent to the CN for triggering the cell-specific overload stop message, and the control message may be sent to the fallback NE.

The configuration message may be sent from or via an Operations and Support System (OSS). At least one of the sensitive cells, the excluded cells and the fallback cells may be stored in a database. The database may be updated based on reports from mobile devices wirelessly connected to the RAN. Alternatively or in addition, the configuration message may be sent from the database or derived from the database. For example, the OSS may query the database for generating or sending the configuration message.

The mobile devices may report a cell as a sensitive cell or as an excluded cell (e.g., a cell to be excluded from the overload function) to the database. The mobile devices may report a cell responsive to detecting or using the cell or an object of the predefined class of objects in said cell. The mobile devices may encompass autonomously driving cars.

As to a second method aspect, a method of configuring an overload function is provided. The method may comprise a step of receiving a configuration message at a core network (CN) for configuring the overload function. The overload function may reduce a signaling load towards the CN from a radio access network (RAN). The RAN may comprise at least one network element (NE). Each NE may serve at least two cells. The configuration message may be indicative of at least one of the at least two cells. The indicated at least one cell may be excluded from the overload function.

The method may further comprise a step of sending an overload message. The overload message may be cell-specific according to the at least one cell indicated in the configuration message. The overload message may be sent from the CN to the at least one NE. The overload message may imply or be indicative of an overload status at the CN.

The method may further comprise or initiate any of the steps disclosed in the context of the first method aspect or steps corresponding thereto.

As to a third method aspect, a method of configuring an overload function in a cellular network comprising a core network (CN) and a radio access network (RAN) is provided. The overload function may reduce a signaling load from the RAN towards the CN. The method may comprise a step of receiving a message at a network element (NE) of the RAN. The NE may serve at least two cells. The message may comprise a configuration message indicative of at least one of the at least two cells. The indicated at least one cell may be excluded from the overload function. Alternatively or in addition, the message may comprise an overload message, which is cell-specific for excluding at least one of the at least two cells from the overload function. The overload message may imply or be indicative of an overload status at the CN.

The method may further comprise a step of applying the overload function at the NE selectively to at least one of the at least two cells according to at least one of the configuration message and the overload message.

The method may further comprise or initiate any of the steps disclosed in the context of the first or second method aspect or steps corresponding thereto.

The first aspect of the technique may be implemented in one or more nodes connected with the cellular network for controlling or configuring the cellular network, e.g., in a network manager (NM) or an operations support system (OSS). The second aspect of the technique may be implemented in the CN, e.g., in a Mobility Management Entity (MME), a Mobility Management Function (MMF) or an Access and Mobility Functions (AMF). The third aspect of the technique may be implemented in the RAN, e.g., in one or more of the NEs or any node of the RAN. Furthermore, the technique may be implemented in a system comprising two or all of the aspects. Moreover, while the technique is described for different domains of the cellular network such as operations control, CN and RAN, the technique may be implemented in a system that uses another domain structure. For example, two or all of the aspects may be indistinguishably combined.

In any aspect, a NE may be a radio base station (RBS) of the RAN. The RBS may encompass any station that is configured to provide radio access to one or more mobile devices. The NE may serve a plurality of mobile devices within each of its cells. Examples for the NE may include a 3G base station or Node B (NB), 4G base station or eNodeB (eNB), a 5G base station or gNodeB (gNB), an access point (AP), e.g., a Wi-Fi AP, and a network controller (e.g., according to Bluetooth, ZigBee or Z-Wave).

The cellular network, particularly the RAN, may be implemented according to the Global System for Mobile Communications (GSM), the Universal Mobile Telecommunications System (UMTS), Long Term Evolution (LTE) and/or New Radio (NR or 5G). The overload function may be backward compatible and/or extend those defined for 3GPP LTE or 5G without being limited thereto. Each aspect of the technique may be implemented using an Application Protocol for the communication between CN and RAN, or on a Physical Layer (PHY), a Medium Access Control (MAC) layer, a Radio Link Control (RLC) layer and/or a Radio Resource Control (RRC) layer of a protocol stack for the radio communication.

The mobile device may be configured for peer-to-peer communication (e.g., on a sidelink) and/or for accessing the RAN (e.g. on an uplink and/or a downlink). The radio device may be a user equipment (UE, e.g., a 3GPP UE), a mobile or portable station (STA, e.g. a Wi-Fi STA), a device for machine-type communication (MTC), a device for narrowband Internet of Things (NB-IoT) or a combination thereof. Examples for the UE and the mobile station include a mobile phone and a tablet computer. Examples for the portable station include a laptop computer and a television set. Examples for the MTC device or the NB-IoT device include robots, sensors and/or actuators, e.g., in manufacturing, automotive communication and home automation. The MTC device or the NB-IoT device may be implemented in household appliances and consumer electronics. Examples for the combination include a self-driving vehicle, a door intercommunication system and an automated teller machine.

As to another aspect, a computer program product is provided. The computer program product comprises program code portions for performing any one of the steps of the method aspect disclosed herein when the computer program product is executed by one or more computing devices. The computer program product may be stored on a computer-readable recording medium. The computer program product may also be provided for download via a data network, e.g., via the Internet and/or the cellular network, particularly through the CN. Alternatively or in addition, the method may be encoded in a Field-Programmable Gate Array (FPGA) and/or an Application-Specific Integrated Circuit (ASIC), or the functionality may be provided for download by means of a hardware description language.

As to a first device aspect, a device for configuring an overload function in a cellular network comprising a core network (CN) and a radio access network (RAN) is provided. The overload function may reduce a signaling load from the RAN towards the CN. The RAN may comprise at least one network element (NE). Each NE may serve at least two cells of the RAN. The device may be configured to perform the first method aspect. Alternatively or in addition, the device may comprise a sending unit configured to send a configuration message to the cellular network. The configuration message may be indicative of at least one of the at least two cells. The at least one indicated cell may be excluded from the overload function.

As to a further first device aspect, a device for configuring an overload function in a cellular network comprising a core network (CN) and a radio access network (RAN) is provided. The overload function may reduce a signaling load from the RAN towards the CN. The RAN may comprise at least one network element (NE). Each NE may serve at least two cells of the RAN. The device may comprise at least one processor and a memory. Said memory may comprise instructions executable by said at least one processor whereby the device is operative to send a configuration message to the cellular network. The configuration message may be indicative of at least one of the at least two cells. The at least one indicated cell may be excluded from the overload function.

As to a second device aspect, a device for configuring an overload function is provided. The device may be configured to perform the second method aspect. Alternatively or in addition, the device may comprise a receiving unit configured to receive a configuration message at a core network (CN) for configuring the overload function. The overload function may reduce a signaling load towards the CN from a radio access network (RAN). The RAN may comprise at least one network element (NE). Each NE may serve at least two cells. The configuration message may be indicative of at least one of the at least two cells. The indicated at least one cell may be excluded from the overload function.

As to a further second device aspect, a device for configuring an overload function is provided. The device may comprise at least one processor and a memory. Said memory may comprise instructions executable by said at least one processor whereby the device is operative to receive a configuration message at a core network (CN) for configuring the overload function. The overload function may reduce a signaling load towards the CN from a radio access network (RAN). The RAN may comprise at least one network element (NE). Each NE may serve at least two cells. The configuration message may be indicative of at least one of the at least two cells. The indicated at least one cell may be excluded from the overload function.

As to a third device aspect, a device for configuring an overload function in a cellular network comprising a core network (CN) and a radio access network (RAN) is provided. The overload function may reduce a signaling load from the RAN towards the CN. The device may be configured to perform the third method aspect. Alternatively or in addition, the device may comprise a receiving unit configured to receive a message at a network element (NE) of the RAN. The NE may serve at least two cells. The message may comprising at least one of a configuration message indicative of at least one of the at least two cells, which is excluded from the overload function, and an overload message, which is cell-specific for excluding at least one of the at least two cells from the overload function and implies or is indicative of an overload status at the CN.

As to a further third device aspect, a device for configuring an overload function in a cellular network comprising a core network (CN) and a radio access network (RAN) is provided. The overload function may reduce a signaling load from the RAN towards the CN. The device may comprise at least one processor and a memory. Said memory may comprise instructions executable by said at least one processor whereby the device is operative to receive a message at a network element (NE) of the RAN. The NE may serve at least two cells. The message may comprise at least one of a configuration message indicative of at least one of the at least two cells, which is excluded from the overload function, and an overload message, which is cell-specific for excluding at least one of the at least two cells from the overload function and implies or is indicative of an overload status at the CN.

As to a still further aspect, a base station configured to communicate with a user equipment (UE) is provided. The UE may embody any of the afore-mentioned mobile devices. The base station may comprise any feature of the third device aspect. Alternatively or in addition, the base station may comprising a radio interface and/or processing circuitry configured to execute any one of the steps of the third method aspect.

As to a still further aspect, a communication system including a host computer is provided. The host computer may comprise processing circuitry configured to provide user data. The host computer may further comprise a communication interface configured to forward the user data to a cellular network for transmission to a user equipment (UE). The cellular network may comprise a base station having a radio interface and processing circuitry. The processing circuitry of the base station may be configured to execute any one of the steps of the third method aspect.

The base station may further be configured to communicate with the UE. The communication system may further include the UE. The UE may be configured to communicate with the base station.

The processing circuitry of the host computer may be configured to execute a host application, thereby providing the user data. The UE may comprise processing circuitry configured to execute a client application associated with the host application.

As to a still further aspect, a method implemented in a base station is provided. The method may comprise any one of the steps of the third method aspect.

As to a still further aspect, a method implemented in a communication system including a host computer, a base station and a user equipment (UE) is provided. The method may comprise any one of the steps of the third method aspect. The method may comprise a step of providing user data at the host computer. The method may further comprise a step of initiating, at the host computer, a transmission carrying the user data to the UE via a cellular network comprising the base station, wherein the base station is configured to execute the any one of the steps of the third method aspect.

The method may further comprise a step of transmitting the user data at the base station. Alternatively or in addition, the user data may be provided at the host computer by executing a host application. The method may further comprise a step of executing, at the UE, a client application associated with the host application.

Any one of the devices, the base station, a system (e.g., the communication system) combining the device aspects or any node (e.g., the host computer) or station for embodying the technique may further include any feature disclosed in the context of the method aspect, and vice versa. Particularly, any one of the units and modules, or a dedicated unit or module, may be configured to perform or initiate one or more of the steps of any one of the method aspects.

### BRIEF DESCRIPTION OF THE DRAWINGS

Further details of embodiments of the technique are described with reference to the enclosed drawings, wherein:

FIG. 1 shows a schematic block diagram of a device for configuring an overload function in a cellular network comprising a core network and a radio access network, which may be embodied in or for an operations support system of the cellular network;

FIG. 2 shows a schematic block diagram of a device for configuring an overload function in a cellular network comprising a core network and a radio access network, which may be embodied in or for the core network;

FIG. 3 shows a schematic block diagram of a device for configuring an overload function in a cellular network comprising a core network and a radio access network, which may be embodied in or for the radio access network;

FIG. 4 shows a flowchart for a method of configuring an overload function in a cellular network comprising a core network and a radio access network, which method is implementable by the device of FIG. 1;

FIG. 5 shows a flowchart for a method of configuring an overload function in a cellular network comprising a core network and a radio access network, which method is implementable by the device of FIG. 2;

FIG. 6 shows a flowchart for a method of configuring an overload function in a cellular network comprising a core network and a radio access network, which method is implementable by the device of FIG. 3;

FIG. 7 schematically illustrates an exemplary network environment comprising a cellular network for implementing the devices of FIGS. 2 and 3 or the methods of FIGS. 5 and 6;

FIG. 8 schematically illustrates an exemplary network environment for implementing the devices of FIGS. 1 and 3 or the methods of FIGS. 4 and 6;

FIG. 9 shows a schematic signaling diagram resulting from embodiments of the devices of FIGS. 2 and 3 performing the methods of FIGS. 5 and 6;

FIG. 10 schematically illustrates an exemplary network environment comprising embodiments of the radio access network and the core network;

FIG. 11 schematically illustrates an exemplary network environment comprising embodiments of the radio access network and the core network;

FIG. 12 schematically illustrates an exemplary network environment comprising embodiments of the devices of FIGS. 1 to 3 performing the methods of FIGS. 4 to 6;

FIG. 13 schematically illustrates an exemplary network environment comprising first variants of first embodiments of the devices of FIGS. 1 to 3 performing the methods of FIGS. 4 to 6;

FIG. 14 shows a flowchart for implementing the first variants of the first method embodiments of FIGS. 4 to 6;

FIG. 15 schematically illustrates an implementation of the first variants of the first embodiments of the devices of FIGS. 2 and 3 performing the methods of FIGS. 5 and 6;

FIG. 16 schematically illustrates an exemplary network environment comprising second variants of first embodiments of the devices of FIGS. 1 to 3 performing the methods of FIGS. 4 to 6;

FIG. 17 schematically illustrates an implementation of the second variants of the first embodiments of the devices of FIGS. 2 and 3 performing the methods of FIGS. 5 and 6;

FIG. 18 schematically illustrates a first implementation of the second variants of the first embodiments of the devices of FIGS. 1 to 3 performing the methods of FIGS. 4 to 6;

FIG. 19 schematically illustrates a second implementation of the second variants of the first embodiments of the devices of FIGS. 1 to 3 performing the methods of FIGS. 4 to 6;

FIG. 20 schematically illustrates a third implementation of the second variants of the first embodiments of the devices of FIGS. 1 to 3 performing the methods of FIGS. 4 to 6;

FIG. 21 schematically illustrates a more detailed third implementation of the second variants of the first embodiments of the devices of FIGS. 1 to 3 performing the methods of FIGS. 4 to 6;

FIG. 22 schematically illustrates an exemplary network environment for implementing a reporting of sensitive cells, which is combinable with any embodiment;

FIG. 23 schematically illustrates a more detailed exemplary network environment for implementing a reporting of sensitive cells, which is combinable with any embodiment;

FIG. 24 shows a flowchart for implementing the second variants of the first method embodiments of FIGS. 4 to 6;

FIG. 25 schematically illustrates an exemplary network environment comprising second embodiments of the devices of FIGS. 1 to 3 performing the methods of FIGS. 4 to 6;

FIG. 26 schematically illustrates an implementation of the second embodiments of the devices of FIGS. 1 to 3 performing the methods of FIGS. 4 to 6;

FIG. 27 shows a schematic block diagram of an embodiment of the device of FIG. 1;

FIG. 28 shows a schematic block diagram of an embodiment of the device of FIG. 2;

FIG. 29 shows a schematic block diagram of an embodiment of the device of FIG. 3;

FIG. 30 schematically illustrates a telecommunication network connected via an intermediate network to a host computer;

FIG. 31 shows a generalized block diagram of a host computer communicating via a base station with a user equipment over a partially wireless connection; and

FIGS. 32 and 33 show flowcharts for methods implemented in a communication system including a host computer, a base station and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented in any other radio network, including 3GPP LTE or a successor thereof, MulteFire according to the MulteFire Alliance and/or a Wireless Local Area Network (WLAN) according to the standard family IEEE 802.11 or Wi-Fi.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

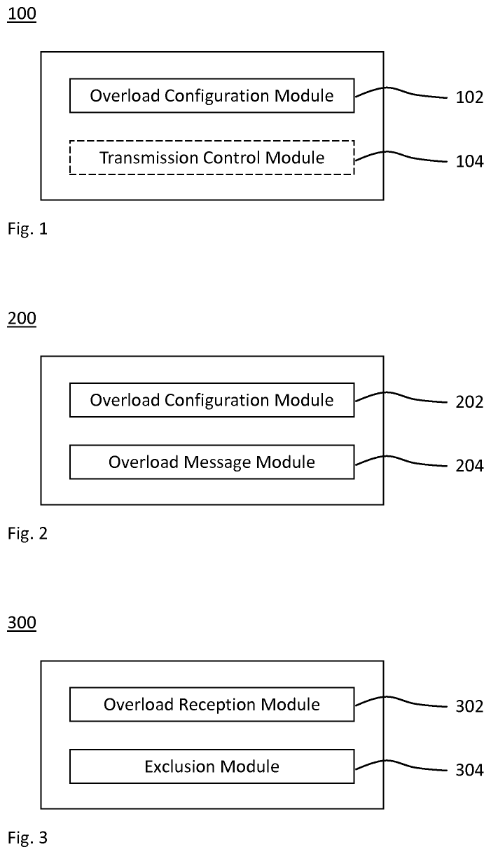

FIG. 1 schematically illustrates a block diagram of a device for configuring an overload function in a cellular network comprising a core network (CN) and a radio access network (RAN). The device is generically referred to by reference sign 100. The overload function reduces a signaling load from the RAN towards the CN. The RAN comprises at least one network element (NE) that each serves at least two cells of the RAN.

The device 100 comprises an overload configuration module 102 that sends a configuration message to the cellular network. The configuration message is indicative of at least one of the at least two cells, which is excluded from the overload function. Optionally, the device 100 further comprises a transmission control module 104 that sends a control command to the CN, e.g., to any one of the at least two NE serving at least two cells. The configuration message or a dedicated control message may comprise the control command. The control command controls radio transmission parameters of at least one excluded cell and/or a fallback cell among the at least two cells.

For example, the device 100 is part of or embodied by a network manager (NM) or operations support system (OSS). Furthermore, any of the modules of the device 100 may be implemented by units configured to provide the corresponding functionality.

FIG. 2 schematically illustrates a block diagram of a device for configuring an overload function in a cellular network comprising a CN and a RAN. The device is generically referred to by reference sign 200. The overload function reduces a signaling load from the RAN towards the CN. The RAN comprises at least one NE that each serves at least two cells of the RAN.

The device 200 comprises an overload configuration module 202 that receives a configuration message at the CN for configuring the overload function. The configuration message is indicative of at least one of the at least two cells, which is excluded from the overload function. The device 200 further comprises an overload message module 204 that sends an overload message from the CN to the at least one NE. The overload message is cell-specific according to the at least one cell indicated in the configuration message. The overload message implies or is indicative of an overload status at the CN.

For example, the device 200 is part of or embodied by the CN, e.g., a Mobility Management Entity (MME) or an Access and Mobility Function (AMF) of the CN. Furthermore, any of the modules of the device 200 may be implemented by units configured to provide the corresponding functionality.

FIG. 3 schematically illustrates a block diagram of a device for configuring an overload function in a cellular network comprising a CN and a RAN. The device is generically referred to by reference sign 300. The overload function reduces a signaling load from the RAN towards the CN. The RAN comprises at least one NE that each serves at least two cells of the RAN.

The device 300 comprises an overload reception module 302 that receives a message at a NE of the RAN, which NE serves at least two cells. The message comprises a configuration message indicative of at least one of the at least two cells, which is excluded from the overload function, and/or an overload message, which is cell-specific for excluding at least one of the at least two cells from the overload function. The configuration message may be received from the device 100. The overload message may be received from the device 200. The overload message implies or is indicative of an overload status at the CN.

Optionally, the device 300 further comprises an exclusion module 304 that applies the overload function at the NE selectively to at least one of the at least two cells according to the configuration message and/or the overload message. For example, the overload function is selectively applied at the NE to a proper subset of the at least two cells served by the NE based on the configuration message and/or the overload message.

For example, the device 300 is part of or embodied by the RAN, e.g., the at least one NE. Furthermore, any of the modules of the device 300 may be implemented by units configured to provide the corresponding functionality.

An embodiment of any one of the devices 100, 200 and 300 may further comprise any feature described in the context of the respectively other devices or a feature corresponding thereto. Moreover, while the technique is described herein in the context of network environments and systems including one or more embodiments of the devices 100, 200 and 300 for clarity and conciseness, any embodiment of the individual devices 100, 200 and 300 may further comprise any feature described herein in the context of network environments or system.

In the context of any one of the devices 100, 200 and 300, any one of the NEs may comprise a radio base station (RBS) or gateway of the RAN, nodes connected to the RAN for controlling the RBS or a combination thereof. The RBS may encompass a network controller (e.g., a Wi-Fi access point) or a radio access node (e.g. a 3G Node B, a 4G eNodeB or a 5G gNodeB) of the RAN. The RBS may be configured to provide radio access to one or more mobile devices.

One or more mobile devices may be wirelessly connected to the RAN, e.g., to the NE that is serving a cell in which the mobile device is located. The mobile device may be any radio device configured for accessing the RAN, for example a vehicle configured for radio-connected and/or autonomous driving. Alternatively or in addition, the mobile device may be wirelessly connected or connectable to another mobile device, for example another vehicle. The mobile devices may be configured for mutual sidelinks scheduled by the NE or for wireless ad hoc connections without scheduling by the NE. For example, the mobile devices may include a mobile or portable station, a user equipment (UE), a device for machine-type communication (MTC) and/or a device for (e.g., narrowband) Internet of Things (IoT).

By excluding the at least one cell individually from the overload function, the technique may prevent sensitive cells from being affected by the overload function, e.g., when an overload start message triggering the overload function is sent to the corresponding NE.

The overload function is applied individual by the NE to one or more cells according to the configuration message or the cell-specific overload message. The overload function may be applied by restricting the service provided by the NE in said one or more individual cells. In one example, the overload message is an overload start message indicative of one or more types of data services or calls to be rejected when the NE applies the overload function. The data services or calls may be rejected at a Radio Resource Control (RRC) layer of a communication protocol used for the radio communication between the NE and the mobile device. An example of the indicated type may correspond to rejecting RRC connection establishments for non-emergency mobile originated data transfer. Alternatively or in addition, an example of the indicated type may correspond to only permitting RRC connection establishments for emergency sessions and mobile terminated services.

An implementation of the technique may be compatible with the overload function defined in the document 3GPP TS 36.413, e.g., Version 14.1.0 or 14.4.1. For example, an implementation of the technique may be compatible with at least one or all types of rejections listed in clause 8.7.6.2 of the document 3GPP TS 36.413.

In a first embodiment, the overload start message as sent by the device 200 in the CN is cell-specific according to the configuration message received at the CN and/or the overload start message as received by the device 300 in the RAN is treated on a cell basis according to the configuration message received at the RAN. In a second embodiment, when a sensitive cell fails, a fallback cell associated with the sensitive cell is reconfigured in order to cover the area of failed sensitive cell. The reconfiguration may comprise sending, to the fallback cell, a cell-specific overload stop message from the device 200 in the CN according to the configuration message received at the CN. The configuration message may be indicative of the fallback cell as being excluded from the overload function.

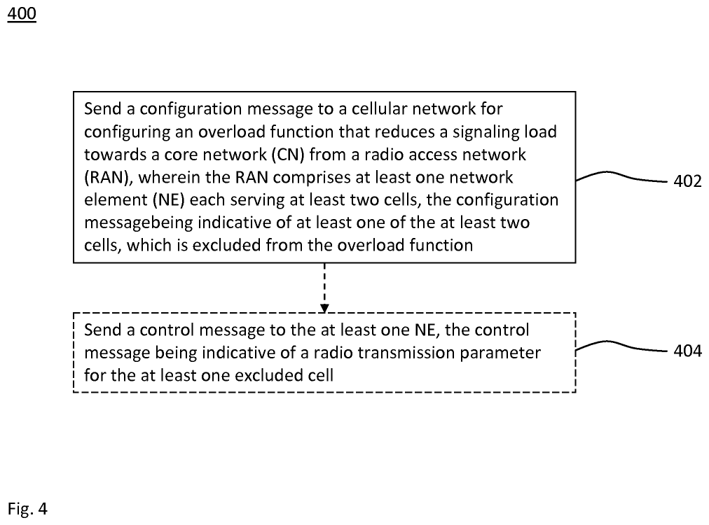

FIG. 4 shows a flowchart for a method 400 of configuring an overload function in a cellular network comprising a CN and a RAN. When applied, the overload function reduces a signaling load from the RAN towards the CN. The RAN comprises one or more NEs each of which is configured to serve at least two cells of the RAN. The method 400 comprises a step 402 of sending a configuration message to the cellular network. The configuration message is indicative of at least one of the at least two cells, which is excluded or is to be excluded from the overload function, e.g., from the service-restricting effect of the overload function.

The at least one excluded cell may be a fallback cell. Optionally, a failure of a NE serving a sensitive cell is detected in a step 404. Responsive to the detected failure, the configuration message sent in the step 402 or a further control message sent in the step 404 comprises a control command that controls a fallback cell associated with the sensitive cell to cover the sensitive cell. For example, the control command is indicative of a radio transmission parameter for the fallback cell.

The method 400 may be performed by the device 100, e.g., at or using the NM and/or the OSS for accessing, controlling and/or configuring the cellular network. For example, the modules 102 and 104 may perform the steps 402 and 404, respectively.

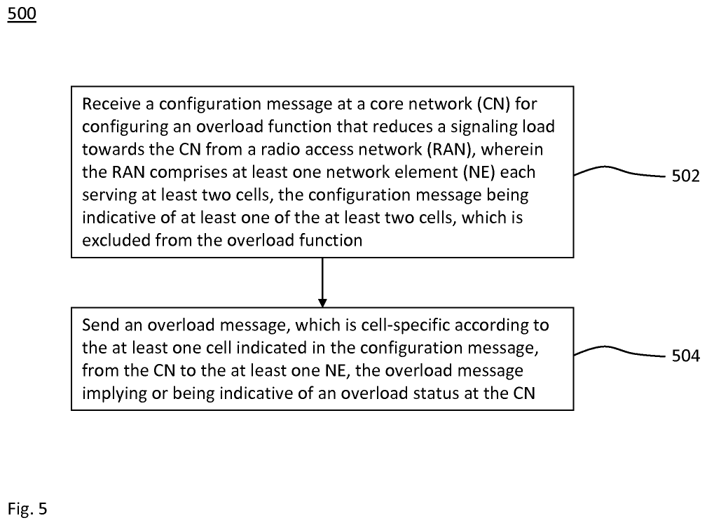

FIG. 5 shows a flowchart for a method 500 of configuring an overload function in a cellular network comprising a CN and a RAN. When applied, the overload function reduces a signaling load from the RAN towards the CN. The RAN comprises one or more NEs each of which is configured to serve at least two cells of the RAN. The method 500 comprises a step 502 of receiving a configuration message at the CN, e.g., the MME or AMF. The configuration message is indicative of at least one of the at least two cells, which is excluded or is to be excluded from the overload function, e.g., from the service-restricting effect of the overload function.

Optionally, a cell-specific overload message is sent from the CN to the at least one NE in a step 504. The overload message is cell-specific according to the at least one cell indicated in the configuration message. Furthermore, the overload message implies or is indicative of an overload status at the CN.

The method 500 may be performed by the device 200, e.g., at or using the MME and/or the AMF. The device 200 may store in the step 502 the configuration of the overload function received in the configuration message and/or may send at least portions of the received configuration to the NEs in the step 504. For example, the modules 202 and 204 may perform the steps 502 and 504, respectively.

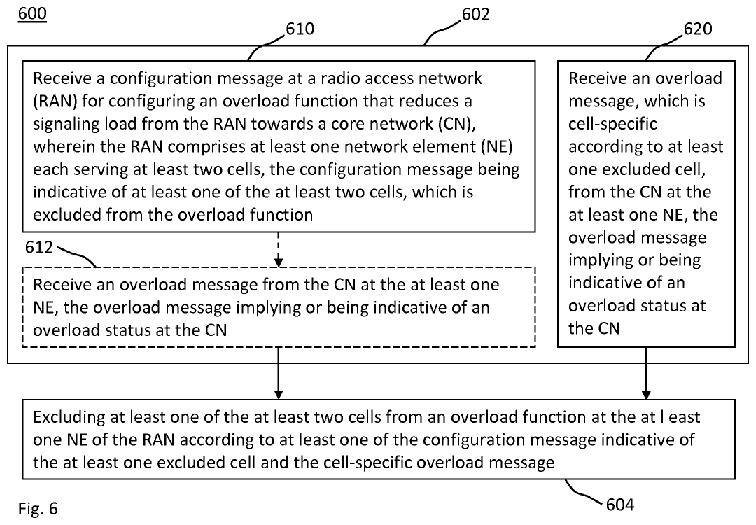

FIG. 6 shows a flowchart for a method 600 of configuring an overload function in a cellular network comprising a CN and a RAN. When applied, the overload function reduces a signaling load from the RAN towards the CN. The RAN comprises one or more NEs each of which is configured to serve at least two cells of the RAN. The method 600 comprises a step 602 of receiving a message at a NE of the RAN. The NE is configured to serve at least two cells. More specifically, the message may be a configuration message and/or an overload message. That is, the step 602 may comprise a step 610 of receiving a configuration message and/or a step 620 of receiving an overload message.

The configuration message is indicative of at least one of the at least two cells, which is excluded or is to be excluded from the overload function. Based on the reception 610 of the configuration message, a further reception 612 of an (e.g., cell-unspecific) overload message may enable or disable the overload function with at the granularity of individual cells as indicated in the configuration message.

Alternatively or in addition, the reception 620 of the cell-specific overload message excludes at least one of the at least two cells from the overload function. For example, the cell-specific overload message may enable or disable the overload function with at the granularity of individual cells as indicated in the cell-specific overload message.

Furthermore, the cell-specific overload message or the cell-unspecific overload message implies or is indicative of an overload status at the CN.

Optionally, the overload function is applied at the NE in a step 604. The step 612 and/or the step 620 may trigger the step 604. The overload function is applied selectively to at least one of the at least two cells according to the configuration message and/or the overload message. For example, if the overload status is an overloaded state, service restrictions may be enforced by the NE in cells that are not excluded. Responsive to the indicated at least one excluded cell, full or regular service may be provided by the NE in the at least one excluded cell. If the overload status is a regular state, full or regular service may be provided by the NE in all of its cells.

The method 600 may be performed by the device 300, e.g., at or using the NE. The at least one excluded cell may be stored at the NE. For example, the modules 302 and 304 may perform the steps 602 and 604, respectively.

The mobile devices may be configured for stand-alone radio communication, ad hoc radio networks and/or vehicular radio communications (V2X), particularly according to technical standard documents of the Third Generation Partnership Project (3GPP). In Release 12, the 3GPP standard for Long Term Evolution (LTE) had been extended with support of device-to-device (D2D) communications (also referred to as “sidelink” communications). D2D features (also referred to as Proximity Services, ProSe) are targeting both commercial and Public Safety applications. ProSe features enabled since 3GPP LTE Release 12 include device discovery, i.e., one mobile device is able to sense the proximity of another mobile device (and, e.g., an associated application) by broadcasting and detecting discovery messages that carry device and application identities. Further ProSe features enable direct communication based on physical channels terminated directly between devices. Such features are defined, inter alia, in the documents 3GPP TS 23.303, Version 15.0.0, and 3GPP TS 24.334, Version 15.1.0.

The sensitive cells may comprise cells that cover roads for V2X communications. In 3GPP LTE Release 14, the D2D communications were further extended to support of V2X communications, which include any combination of direct communication between vehicles, pedestrians and infrastructure. While V2X communications may take advantage of a network infrastructure (e.g., the RAN) if available, at least basic V2X connectivity is possible even in case of lacking RAN coverage.

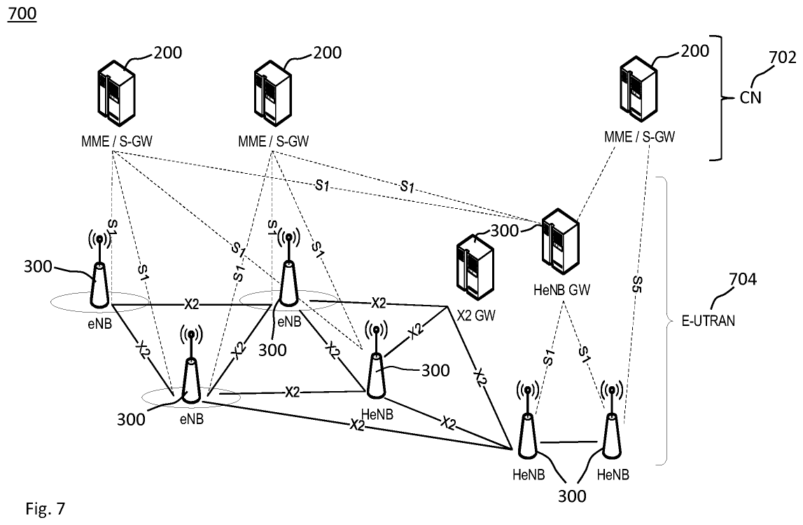

FIG. 7 schematically illustrates an exemplary radio environment comprising a cellular network 700 for implementing the technique. The cellular network 700 comprises the CN 702 (e.g., an evolved packet core, EPC) and the RAN 704 (e.g., an evolved UMTS Terrestrial Radio Access Network, eUTRAN).

The cellular network 700 may be implemented according to the 3GPP LTE, e.g., since Release 13. The RAN 704 comprises NEs 300 such as radio access nodes. Examples of the NEs 300 include eNBs, Home eNBs (or HeNBs) and HeNB gateways (or HeNB GWs). An LTE implementation of the CN 702 includes EPC nodes. The EPC 702 may comprise at least one of a Mobility Management Entity (MME) and a Serving Gateway (S-GW), any one of which may embody the device 200.

As schematically illustrated in FIG. 7, an S1 interface connects the NEs 300 (e.g., HeNBs or eNBs) to the CN nodes 200 (e.g., the MME or the S-GW). The HeNBs may be connected via the S1 interface to the HeNB GW. An X2 interface connects peer NEs 300 (e.g., eNBs or HeNBs), optionally via an X2 GW. The interfaces X2 and S1 are also referred to as logical interfaces.

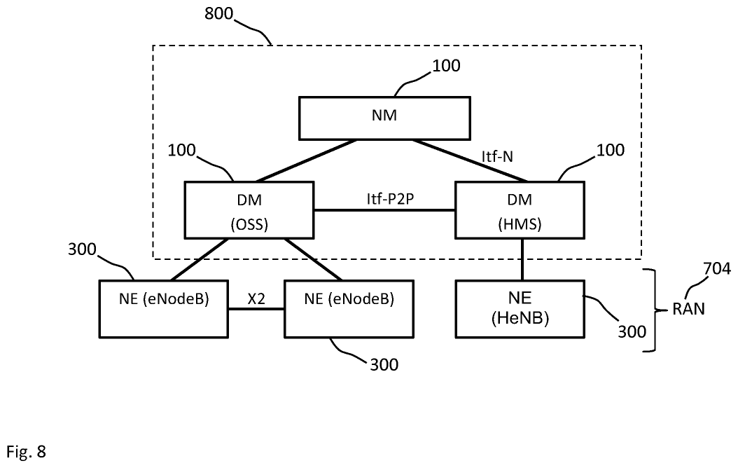

FIG. 8 schematically illustrates an exemplary radio environment comprising a cellular network for implementing the technique, which is combinable with the radio environment of FIG. 7. Feature corresponding to those of FIG. 7 are indicated by like reference signs. The RAN 704 is connected to an operations control domain 800 (also: management system) for controlling and configuring the cellular network. One or more of the nodes may embody the device 100.

The management system 800 controls and configures the NEs 300, e.g., the eNodeBs, by a domain manager (DM), which is also referred to as the OSS. The DM may further be controlled by a network manager (NM). Any one of the DMs and the NM may embody the device 100.

Two NEs 300 are interfaced by the X2 interface. The interface (Itf) between two DMs 100 is referred to as Itf-P2P. The management system 800 may configure the NEs 300 by sending configurations messages such as in the step 402. Furthermore, the management system 800 may receive observations (e.g., reports or measurements) associated to features in the NEs 300. For example, the DM 100 observes and configures NEs 300. The NM 100 observes and configures the DM as well as the NEs 300 via the DM 100.

By means of configuration via the DM 100, the NM 100 and related interfaces, functions over the X2 and S1 interfaces can be carried out in a coordinated way throughout the RAN 704, eventually involving the CN 702, i.e. the MME 200 and the S-GWs 200, e.g., as illustrated in FIG. 7.

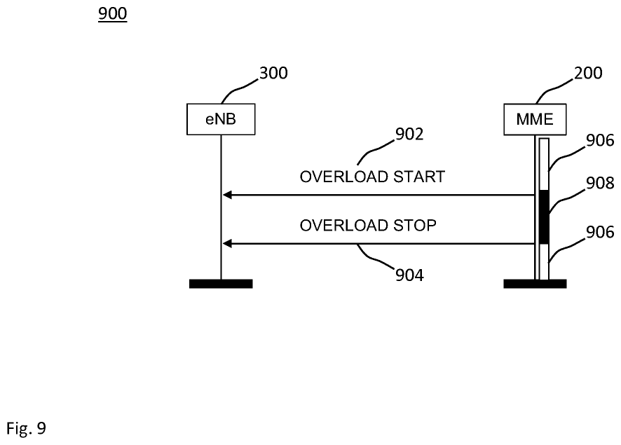

FIG. 9 shows a schematic signaling diagram 900 for an overload procedure resulting from embodiments of the devices 200 and 300 performing the methods 500 and 600. Signalings 902 and 904 of the overload procedure are example for the overload message.

Responsive to the overload status comprising an overloaded state 908 (also: a situation of overload) at the CN 702, e.g., at the MME 200, the MME 200 uses the S1 interface to trigger an overload start message 902 that signals the overload status to the RAN 704, more specifically, to the NE 300 (e.g., an eNB).

Optionally, the overload start procedure comprises the CN node 200 (e.g., the MME) signaling to the NE 300 (e.g., the eNB) a series of Overload Actions in the overload start message 902. The Overload Actions configure the NE 300 (e.g., the eNB) to reject the specified connections of mobile devices (e.g., UEs) towards the signaling CN node 200 (e.g., the MME). The Overload Actions may comprise at least one of the following examples. A first example comprises rejecting RRC connection establishments for non-emergency MO Data Transfer. A second example comprises rejecting RRC connection establishments for Signaling. A third example comprises permitting Emergency Sessions and mobile terminated services only. A fourth example comprises permitting High Priority Sessions and mobile terminated services only. A fifth example comprises rejecting delay tolerant access.

Alternatively or together with the Overload Action, a Traffic Load Reduction Indication is signaled from the CN node 200 to the NE 300. This information specifies the percentage of the type of traffic relative to the instantaneous incoming rate at the NE 300, as indicated in an Overload Action Information Element (IE), to be rejected.

Once the overloaded state ceases at the CN node 200 (e.g., the MME), e.g., when the overload status return to a regular state 906, the CN node 200 sends an overload stop message 904. Responsive to the overload stop message 904, the NE 300 (e.g., the eNB) does not reject connections due to CN overload (e.g., MME overload).

In the case of receiving 612 cell-unspecific overload messages 902 and/or 904, the at least one cell excepted from the overload function is defined by the configuration message. In the case of receiving 620 cell-specific overload messages 902 and/or 904, the at least one cell excepted from the overload function is defined by the overload message 902 and 904, respectively.

Current 3GPP agreements for a 5G implementation of the cellular network 700 comprise an overload function (particularly overload massages such as Overload Start and Overload Stop). The overload function may protect, and/or may be triggered by, the AMF entity 200 (also referred to as Mobility Management Function or MMF entity), which is with respect to the RAN 704 functionally similar or equivalent to the MME 200 in an LTE implementation.

The overload function is described herein for 5G and LTE implementations for clarity and not limitation. The overload function may be implemented at any node or entity that terminates the interface between the RAN 704 and the CN 702. The overload function may be implemented using any signaling procedure with the RAN 704 similar to the overload procedure run over the S1 interface in the LTE implementation of the cellular network 700.

Embodiments of the technique enable the CN 702 to send the overload messages 902 and/or 904 on a cell basis, i.e., the overload messages are cell-specific in the step 504 or 620, e.g., instead of a NE basis. For example, the overload messages may be sent to the NE separately for each cell of the NE. Alternatively or in addition, the overload messages may be sent to the NE separately for a group of excluded and/or sensitive cells and/or a group of not excluded and/or non-sensitive cells. Alternatively or in addition, the overload messages sent to the NE may be indicative of the at least one excluded cell and/or the at least one cell subjected to the overload function.

Same or further embodiments enable the CN 702 to send conventional or cell-unspecific overload messages 902 and/or 904, wherein applying the overload function a cell basis is defined by the configuration message received according to the step 610.

Hence, the overload messages 902 and/or 904 can control applying the overload function on a cell level and not only on a site basis (or NE basis). An advantage of the cell-specific application of the overload function (e.g. by sending the overload start message 902 on a cell basis or by configuring the NE with at least one cell excluded from the overload function) is illustrated in the following example.

For connected driving, emergency services or autonomous driving, one or more roads in a given region are to be covered by the RAN 704, preferably by a 5G implementation of the RAN 704. The cellular network 700 comprises, by way of example, 600 NEs 300 (e.g., 5G sites or gNBs) to cover the one or more roads. Each NE 300 may be configured to serve 3 cells. In total, the RAN 704 comprises in the region 1800 cells with. Suppose that in our example one cell, say cell₁, of each of the 600 NEs 300 is covering the road, and the other two cells, say, cell₂ and cellₐ, cover the areas surrounding the road. As a result, of this deployment of the cellular network 700, 600 cells (namely 600 cell₁) are necessary in order to cover the road, say road X (e.g., for autonomously driving cars). Suppose that during the overloaded state 908 (e.g., an MME congestion), the CN node 200 can spare only 600 cells as maximum cells to be up. In other words, during the overloaded state 908, the CN 702 is capable of handling only 600 cells.

As a reference example, an MME conventionally sends an overload start message to 400 of its NEs to block the rest of the cells, i.e., further 1200 cells. That is, the MME has to send the overload start message on a site basis, which result in maintaining 200 NEs in regular operational, because each site has three cells so that service is maintained in 200×3=600 cells at most. Maintaining 200 NEs means keeping 200 cell₁ covering the road X, as one cell of each of the 600 NEs covers the road X in the given deployment. As 600 cell₁ are needed to cover road X, with 200 cell₁ in regular operation, the reference example covers only ⅓ of the road X.

In contrast, the embodiments enable marking all 600 cell₁ as important or sensitive cells by means of the configuration message being indicative of these cells as being excluded from the overload function. The overload start message 902 is sent (in the steps 504 or 620) on the basis of cells or the effect of the overload start message 902 (sent in the step 612) is cell-specific due to the configuration message. Hence, the required reduction of the signaling load (from 1800 active cells to 600 active cells) is achieved and the 600 cells for covering all of the road X are maintained in regular operation.

As a conclusion, e.g., for any remaining capacity of the CN node 200 (e.g., the MME) that is available during the overloaded state 908 (e.g., the congestion of the CN node 200), by sending the overload start message on a cell basis, at least some embodiments can cover more geographically important or prioritized areas or locations than in the case of a prior art scenario including sending an overload start message on a site basis (i.e., NE basis).

Any embodiment described herein may be implemented in a cellular network 700 that is compatible with a 5G or NextGen standardization at 3GPP, e.g., as defined in the workgroup SA2 WG at 3GPP. The corresponding RAN 704 may also be referred to as a NR interface, 5G RAN or G-UTRAN. The corresponding CN 702 may be referred to as a Next Generation Packet Core Network (NG-CN or NGC).

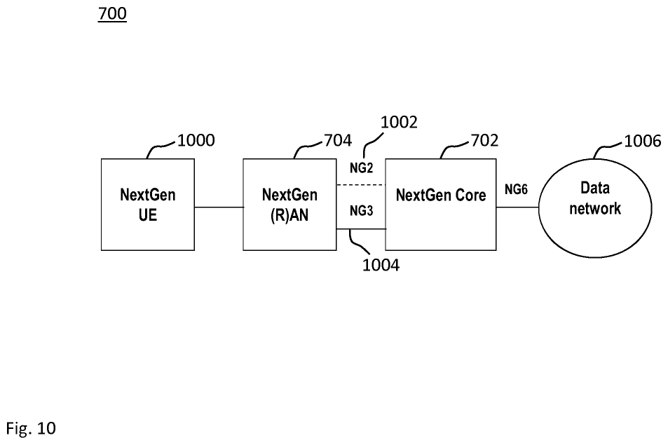

A cellular network 700 according to the 3GPP Next Generation (NextGen, NG or 5G) may comprise reference points between the CN 702, the RAN 704 and the mobile device (i.e., the UE), e.g., according to the document 3GPP TS 23.799, Version 14.0.0. FIG. 10 shows a high level architecture view of a cellular network 700 implementing the NextGen System comprising examples for a NextGen UE 1000, a NextGen(R)AN 704 and a NextGen Core 702 and their reference points.

A reference point NG1 may define an interface for the control plane between NextGen UE 1000 and the NextGen Core 702. A reference point NG2 at reference sign 1002 may define an interface for the control plane between NextGen (R)AN 704 and NextGen Core 702. A reference point NG3 (at reference sign 1004) may define an interface for the user plane between NextGen RAN or NextGen Access Network (AN) 704 and NextGen Core 702. A reference point NG6 may define an interface between the NextGen Core 702 and a data network 1006. The data network may be an operator external public or private data network (e.g., the Internet) or an intra-operator data network (e.g., for provision of Internet Protocol Multimedia Subsystem, IMS, services). The reference point NG4 corresponds to SGi for 3GPP LTE implementations.

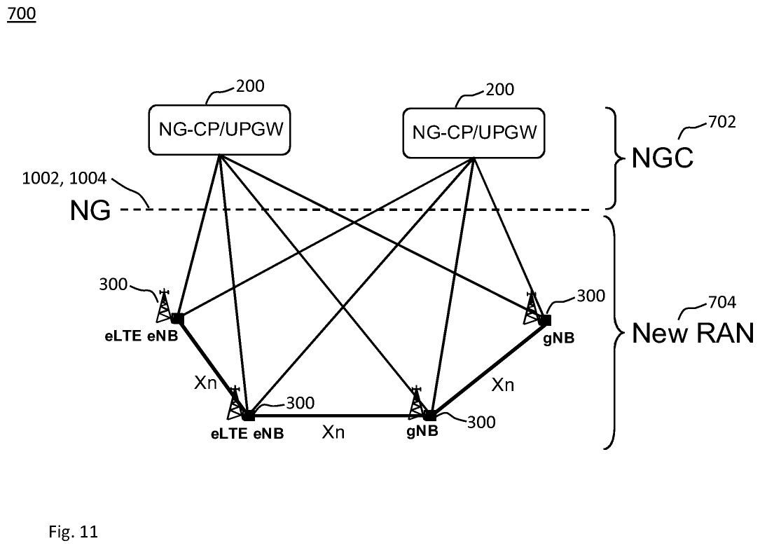

More specifically, the Next Gen RAN 704 may comprise RBSs 300 that support and provide LTE (e.g., evolved LTE) radio access and/or NR radio access. FIG. 11 schematically illustrates an embodiment of the cellular network 700 implementing a New RAN Architecture (e.g., according to the document 3GPP TR 38.801, Version 1.0.0). The New RAN 704 comprises the following logical nodes as examples of the NEs 300. A first example for a NE 300 is a gNB providing the NR U-plane and C-plane protocol terminations towards the UE 1000. A second example of the NE 300 is an eLTE eNB providing the E-UTRA U-plane and C-plane protocol terminations towards the UE 1000.

The logical nodes 300 of the New RAN 704 are interconnected with each other by means of an Xn interface (that may be specified as an evolution of the X2 interface). The logical nodes 300 in the New RAN 704 are connected to the NGC 702 by means of the NG interfaces (more specifically, the NG2 for the control plane and the NG3 for the user plane). The CN 702 comprises gateways 200 for the control plane (NG-CPGWs) and for the user plane (NG-UPGWs), which are collectively abbreviated by NG-CP/UPGWs. The NG interfaces support a many-to-many relation (and corresponding communications) between the gateways 200 in the CN 702 and the logical nodes 300 in New RAN.

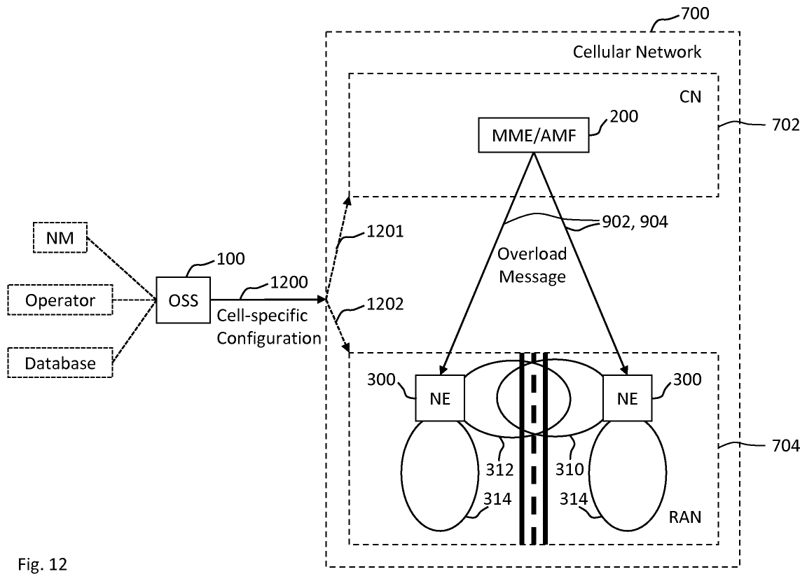

FIG. 12 schematically illustrates a block diagram for embodiments of the devices 100, 200 and 300. The OSS embodying the device 100 sends the configuration message 1200 that is indicative of the one or more excluded cells 310, 312 to the cellular network 700. The OSS 100 may generate the configuration message 1200 based on an input provided by an operator at a terminal, by a NM controlling the OSS 100 and/or by a database. For example, an operator selects some or all of the cells of the RAN 704 that are to be excluded, e.g., as sensitive cells. Alternatively or in addition, the database may store a sensitivity or priority of each of the cells or each excluded cell in the RAN 702.

The configuration message 1200 or a portion 1201 of the configuration message 1200 may be sent to the CN 702, e.g., to the MME or AMF 200. Alternatively or in addition, the configuration message 1200 or a portion 1202 of the configuration message 1200 may be sent to the RAN 704, e.g., to one of the NEs 300.

The CN 702, e.g., the MME 200, sends an overload start message 902 and/or an overload stop message 904 to the RAN 704, e.g., one of the NEs 300. Each NE 300 serves one or more cells. Some of the cells, e.g. the cell 310 and/or the cell 312, are excluded from the overload function, because they are sensitive or essential for certain services provided by the RAN 704, e.g., for covering a road used by autonomously driving vehicles relying upon real-time data provided by the excluded cells. Other cells 314 of the RAN 704 are not excluded. In the exemplary RAN 704 of FIG. 12, each of the NEs 300 comprises at least one excluded cell 310, 312 and at least one not excluded cell 314.

While different embodiments of the technique are separately described herein below for clarity and conciseness, any two or more embodiments may be beneficially combined. In a first embodiment, the overload message comprises the overload start message 902 for cell-selectively enabling the overload function. The one or more excluded cells 310 or 312 in the one or more NEs 300 receiving the overload start message 902 are not affected by the received overload start message 902. In a second embodiment, the overload message comprises the overload stop message 904 for cell-selectively disabling the overload function.

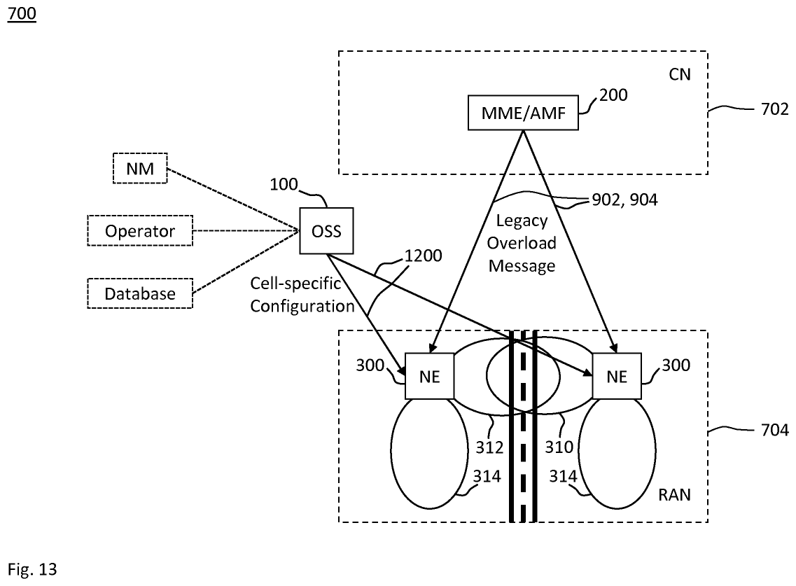

In a first variant of the first embodiment, e.g., as illustrated in FIG. 13, the configuration message 1200 or a portion 1202 of the configuration message 1200 is sent from the OSS 100 to the RAN 704, e.g., to one of the NEs 300, according to the steps 402 and 610 without informing the CN 702, in particular the MME 200. Later when the overload start message 902 is received by the NE 300 in the step 612, the NE 300 applies the overload function only on the cells 314 which are not excluded, e.g., those that are not sensitive cells, according to the step 604.

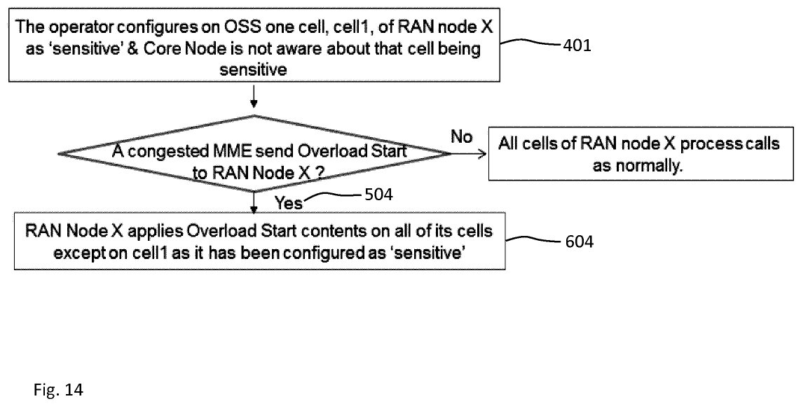

FIG. 14 shows a flowchart for implementing the first variant of the first embodiment. The overload start message 902 is treated on a cell basis. The objective of the first embodiment is to make the contents of the overload start message 902 apply only to non-sensitive cells. The sensitive cells are excluded from applying the overload function. In the first variant, the excluded (e.g., sensitive) cells are only known to the RAN 704 or at least the NE 300 serving at least one of the excluded cells, but not to the CN 702.

Responsive to an operator input 401 (or an input based on reports from the mobile devices), the OSS 100 sends the corresponding configuration message 1200 directly to the one or more pertinent NEs 300. When the CN 702 sends an overload start message 902 according to the step 504. According to the step 604, the NE 300 applies the overload function to its cells, excluding those cells that are indicated in the configuration message 1200. If no overload start message 902 has been sent or responsive to an overload stop message 904, all cells of the NE 300 process data service or call accesses as normally.

In the first variant, the CN 702 is not aware about the identity or the number of the excluded cells. Hence, the CN 702, e.g., the MME or AMF 200, may send conventional (i.e., cell-unspecific) overload messages 902 and/or 904. The first variant may be implemented at the devices 100 and 300 only.

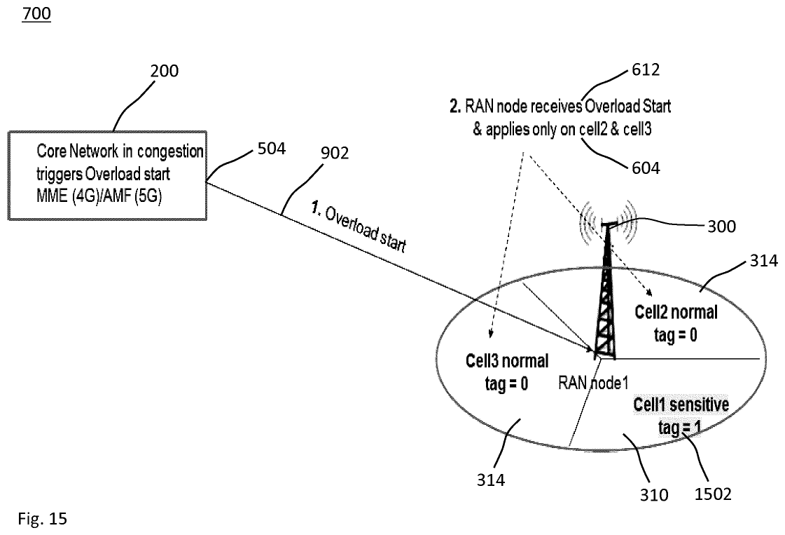

FIG. 15 schematically illustrates an implementation of the first variant of the first embodiment, which may be combined with the other variant or any other embodiment. The configuration message 1200 sent from the OSS (or any node used by an operator to configure the operation of the cellular network 700) to the NEs 300 causes tags 1502 (e.g., binary flags) being set at the NE 300 for its cells. Each tag 1502 may be indicative of whether or not the respective cell is excluded according to the received configuration message 1200. Alternatively or in addition, the tag 1502 may be added (e.g., to some sensitive NEs 300) at deployment or during operation, e.g., via the OSS 100. In the example illustrated in FIG. 15, the tag 1502 being set to 1 is indicative of the cell 310 as being sensitive, service-essential or important.

The operator has only to select the cells 310 of the NE 300 (e.g., an eNB for a 4G implementation or a gNB for a 5G implementation) covering certain (e.g., sensitive) areas by tagging them as excluded. Each of the tags 1502 may be coded in one bit (either excluded or not). Later, any time the NE 300 receives an overload message, e.g., 902 or 904, an entity internal to the NE 300 applies the contents (e.g., the types of service restrictions) according to the received overload message only to the cells that are not excluded according to the tags 1502. The overload message may be structured in the same way as existing overload start or stop messages, which may be beneficial for backward compatibility.

As a consequence, sensitive cells are not affected by the overload start message 902 and continue as in a normal situation 906 to process data services or calls, e.g., coming from the sensitive geographical area. With the first variant of the first embodiment, the MME or AMF 200 is not or needs not to be aware as to the identity and the number of the sensitive cells in the cellular network 700.

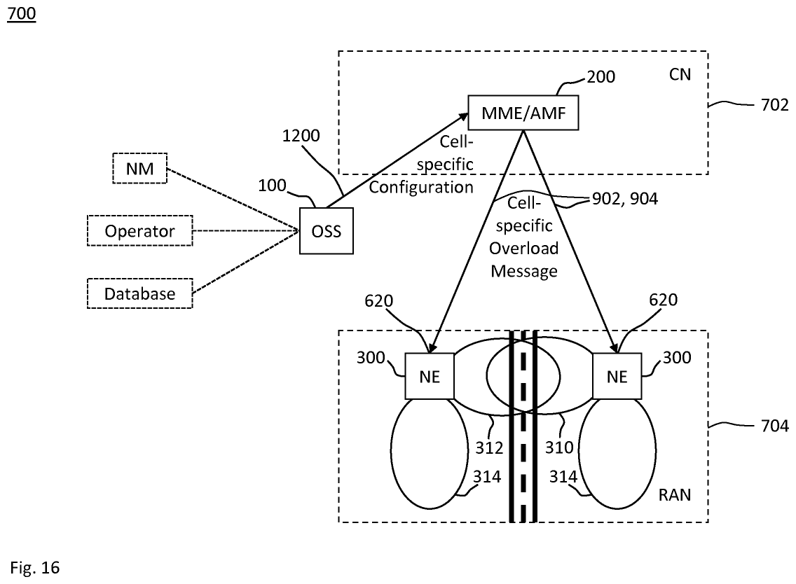

In a second variant of the first embodiment, e.g., as illustrated in FIG. 16, the OSS 100 sends the configuration message 1200 to the CN 702, e.g., to the MME or AMF 200. That is, the information as to cells to be excluded is sent to the CN 702, e.g., so that it is aware about the identity and number of all sensitive cells.

The MME or AMF 200 may use the indicated at least one excluded cell for statistics. Alternatively or in addition, the MME or AMF 200 may set a priority on the sensitive cells and select the cells with the least priority to send the cell-specific overload start message 902 so that or until a required reduction of the signaling load is achieved. For example, a threshold value for the priority below which the cells are not excluded, is increased to additionally bar one or more cells required in order to further relieve the MME or AMF 200 from its congestion or overloaded state 908.

While the first and second variants of the first embodiments have been described for the overload start message 902, the first embodiments may be combined with a second embodiment that uses an overload stop message 904. The overload stop message 904 may be cell-specifically applied based on the configuration message 1200 and/or the overload stop message 904 may be cell-specific by being indicative of the one or more cells to be subjected to the overload function. The overload stop message 904 may be used to reactivate a fallback cell 312 responsive to the failure of a sensitive cell 310.

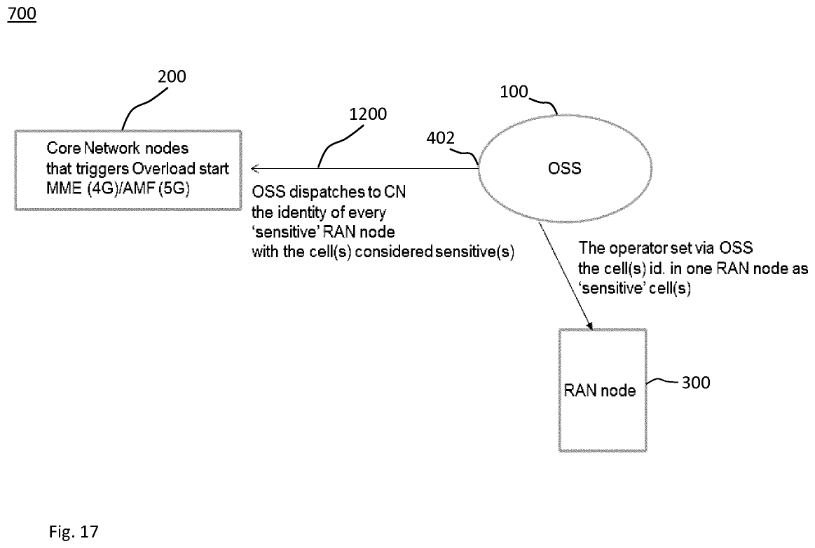

As schematically illustrated in FIG. 17, the first and second variants of the first embodiment may be combined. That is, in addition to the NEs 300 receiving an instant 1202 of the configuration message 1200, the sensitive cells are also indicated to the CN 702, e.g., the MME or AMF 200.

Exemplary implementations of the second variant of the first embodiment are described. The CN 702 is aware about the identity and the number of the excluded (e.g., sensitive) cells 310. The objective is to make the CN 702, e.g., the MME (for 4G) or AMF (for 5G) embodying the device 200, aware of any cell that has been configured as sensitive at the OSS 100.

The configuration message 1200 sent from the OSS 100 to the CN 702 in the step 402 comprises at least one of the following data fields. A first data field comprises the identity of the at least one excluded cell 310. A second data field comprises the identity of the NE 300 (i.e., the node of the RAN 702) serving or controlling the excluded cell 310. Preferably, e.g., in accordance with 3GPP NR or 3GPP LTE, the CN 702 communicates with the NE 300 at a node level. That is, messages to the RAN 704 are addressed to the pertinent NE 300 of the RAN 704 (e.g., not to individual cells). For example, each NE is assigned an Internet Protocol (IP) address. The overload messages 902 and 904 may use the IP and/or may be sent to the respective NE 300 using the IP address. For that purpose, the second data field in the configuration message 1200 sent to the CN 702 may be indicative of the identifier (e.g., the IP address) of the corresponding NE 300. A third data field comprises a priority of the excluded (e.g., sensitive) cell 310. In one example, the priority may be coded in few (e.g., 2, 3 or 4) bits. The priority may be used to gradually exclude (i.e., to gradually bar) the least prioritized sensitive cells in case the MME or AMF 200 is still congested (i.e., in the overloaded state 908) after at least one non-sensitive cell or less prioritized sensitive cells have already been excluded.

The configuration message 1200 comprising at least one of the afore-mentioned three data fields may be sent to the CN 702, particularly the MME or AMF 200, using at least one of the following procedures.

In a first procedure, the configuration message 1200 is sent from or via the OSS 100. Each of the implementations described with reference of FIGS. 16 and 17 may use the first procedure. As soon as the OSS 100 configures any cell 310 in the RAN 704 as sensitive, the OSS 100 dispatches the configuration message 1200 to the CN 702. If the OSS 100 that controls the NE 300 serving the excluded cell is the same one that controls the CN 702, e.g., the MME or AMF 200, whenever a cell 310 is configured as sensitive, the OSS 100 sends that information (e.g., at least one of the three data fields) in the configuration message 1200 to the CN node embodying the device 200, so that the CN node stores the at information for the at least one excluded cell in its database. Optionally, as schematically illustrated in FIG. 17, whenever a cell 310 of one of the NEs 300 is configured as sensitive at the OSS 100, that information is automatically dispatched to a database of the respective NE 300, e.g., as a basic procedures of the OSS 100.

In a second procedure, the configuration message 1200 is sent via dedicated signaling. In many deployments (e.g., because the RAN 704 is bought from one vendor, say “1”, and the CN 702 is bought from another vendor, say “2”), the RAN 704 and CN 702 are not connected to the same OSS 100. In that case one of the following procedure implementations may be applied.

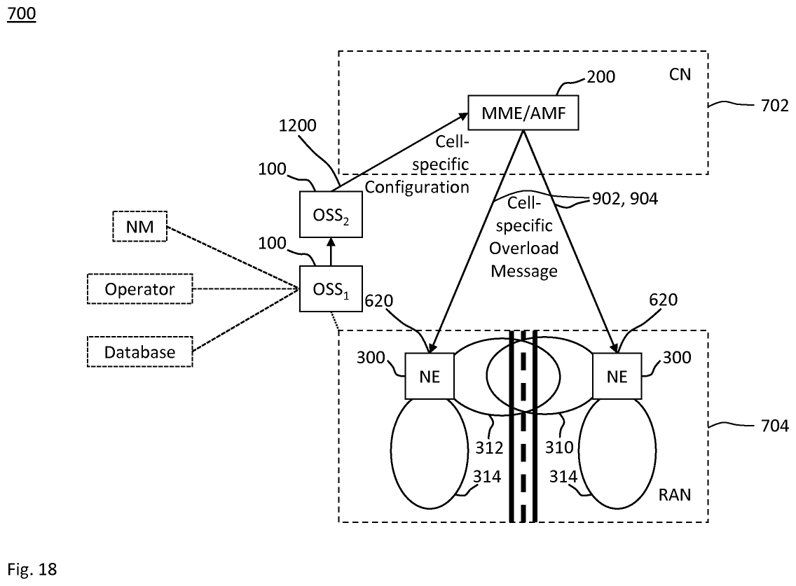

In a first implementation of the second procedure schematically illustrated in FIG. 18, the NEs 300 of the RAN 704 are controlled by one OSS 100, say OSS₁, and the CN nodes 200 of the CN 702 are controlled by another OSS, say OSS₂. The OSS₁ sends the identities of the sensitive cells to the OSS₂. The OSS₂ forwards them to the CN nodes 200 or generates the configuration message 1200 based on the identities of the sensitive cells.

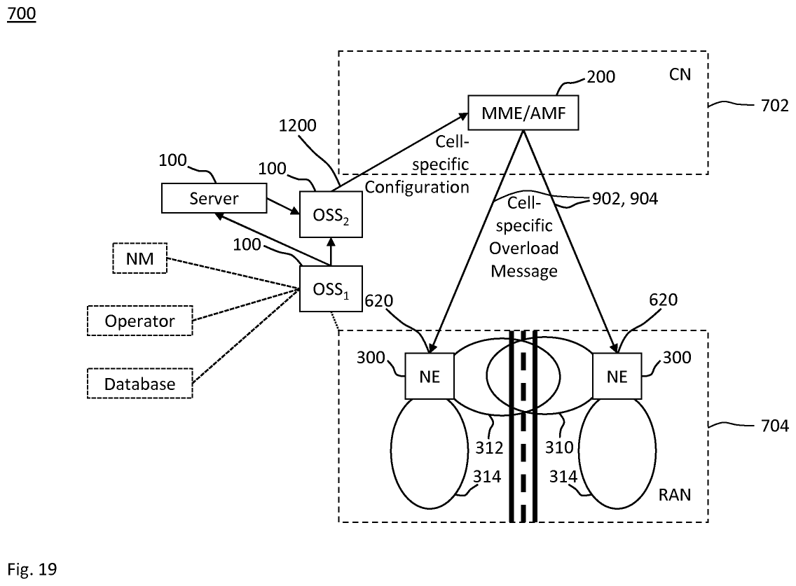

In a second implementation of the second procedure schematically illustrated in FIG. 19, the OSS 100 of vendor “1” sends the identities of all sensitive cells 310 to the CN 702 via a third party server.

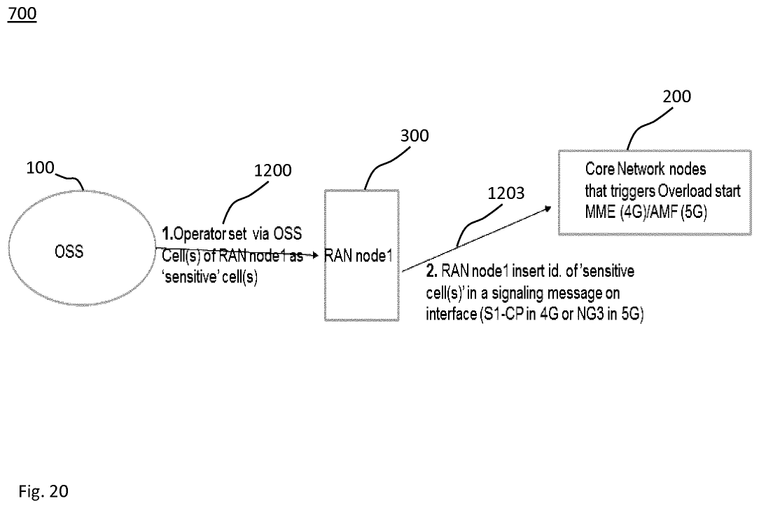

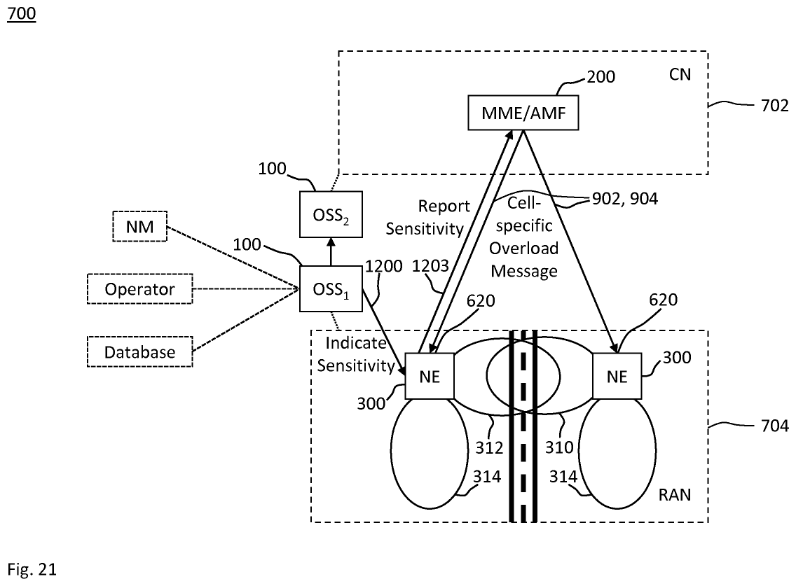

In a third implementation of the second procedure schematically illustrated in FIGS. 20 and 21, after the OSS 100 has configured at least one cell 310 of at least one of the NEs 300 of the RAN 704 as sensitive, the NE 300 signals, based on the configuration message 1200 received in the step 602, to the CN 702 that it serving an excluded cell 310 (e.g., that it is covering a sensitive area) via a dedicated signaling messages 1203 exchanged between the NE 300 and the CN 702. The signaling messages 1203 may be implemented via an S1 Setup Request message and an S1 Setup Response message exchanged during setup of the NE 300 with the MME 300.

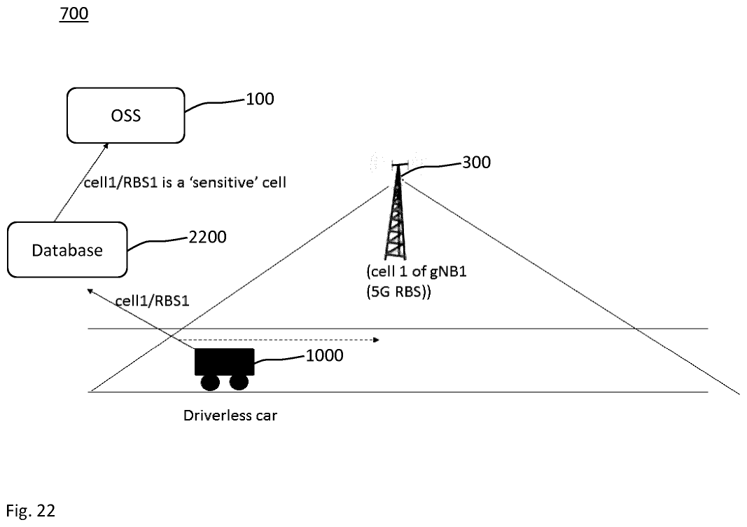

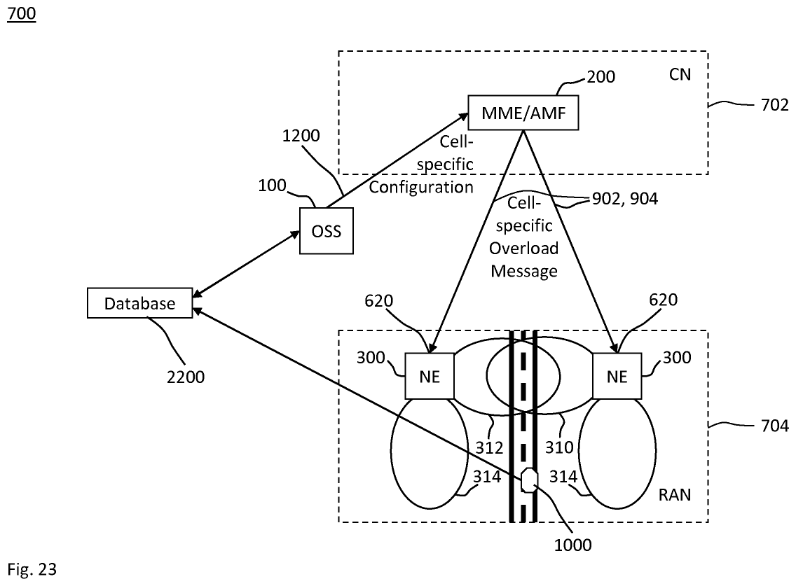

In a third procedure, e.g., as schematically illustrated in FIGS. 22 and 23, cell information (e.g., as to sensitive or service-essential cells) underlying the configuration message 1200 (e.g., at least one of the data fields) is based on reports from mobile devices 1000 connected to the RAN 704, e.g., in the respective cells. The reports from the mobile devices 1000, or their information relevant for the configuration message 1200, are stored in a database 2200. For example, multiple consistent reports from different mobile devices 1000 are required before the reported information is used for generating the configuration message 1200.

The cell information is derived from the reports of the mobile devices 1000 and is reported to the CN 702 by means of the configuration message 1200. The third procedure may be implemented to generate the configuration message 1200 (e.g., periodically or for event-driven updates) without any in advance human configuration, e.g., solely from the database 2200.

The third procedure may be combined with any embodiment and/or the first or second procedure. For example, any afore-mentioned database providing input to the OSS 100 may serve as the database 2200. Optionally, at some stage, the operator may additionally set via the OSS 100 cells 310 to be excluded, e.g., by setting at the OSS 100 or the database 2200 a tag or database entry for the excluded cell to the value 1.

FIGS. 22 and 23 schematically illustrate an embodiment of the cellular network 700 comprising cells 310 covering the roads of an autonomously driving car being an example of a mobile device 1000. For example, multiple autonomously driving cars report every cell on their road to the database 2200 on a server (which may also be referred to as a driverless car server). The driverless car server 2200 forwards the reported cells to the OSS 100, which tags them automatically as excluded (e.g., sensitive) cells 310. For example, any cell covering a road used by an autonomously driving car may be considered as a sensitive cell 310. Based on the database 2200, any variant of any embodiment may be applied.

The reports from the mobile devices 1000 may be indicative of the identity of cells 310 to be excluded and the identity of the corresponding NE 300, i.e., the first and second data fields, respectively. The third data field may be related to the number of reports received or stored at the database 2200 (e.g., per time unit) for said cell 310.

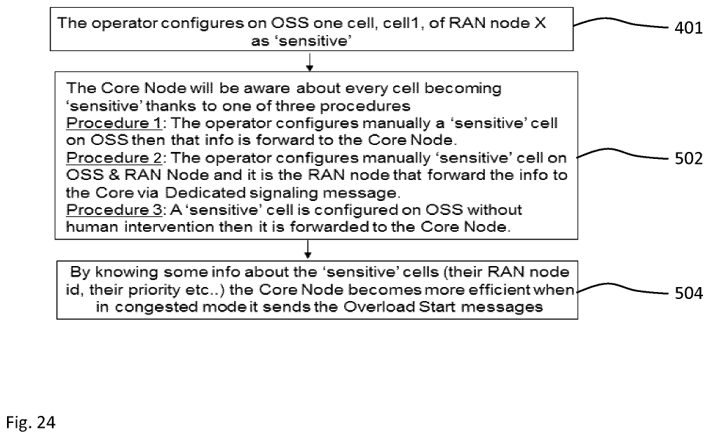

FIG. 24 shows a flowchart for an implementation of the second variant of the first embodiment. Responsive to an operator input 401 and/or the input from the database 2200 based on the reports from the mobile devices, the OSS 100 sends the corresponding configuration message 1200 according to any one of the three procedures in the step 502. Based on the configuration message 1200, the CN node embodying the device 200 sends the overload message, e.g., 902 or 904, to the RAN in the step 504.

Alternatively or in addition to any variant and implementation of the first embodiment, whenever a sensitive cell 310, say cell₁, or the corresponding NE 300, say eNB₁, controlling that cell fails (e.g., goes in outage due to any hardware or software issue), a second embodiment comprises the step 404 of reconfiguring a fallback cell 312 (e.g., a surrounding cell), say cell₂, or a fallback NE 300, say eNB₂, so that the fallback NE 300 covers the sensitive geographical area.

For each sensitive cell 310, another cell from the same NE 300 or from another fallback NE 300 may be associated with the sensitive cell 310 as the fallback cell 312. The fallback cell 312 may be configurable, e.g., responsive to the control command received in the step 404, to provide radio access in the area of the failed cell 310.

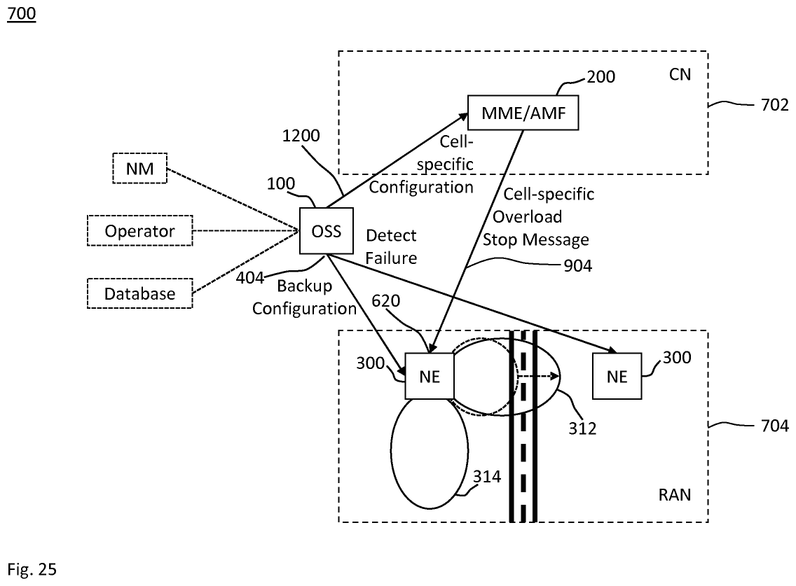

FIG. 25 shows schematic block diagrams for a cellular network 700 comprising second embodiments of the devices 100, 200 and 300. The OSS embodying the device 100 is configured to detect a failure of any one of the NEs 300 or cells in the RAN 704. Whenever any sensitive cell 310 fails, the second embodiment comprises at least one of the following steps, which may be performed in parallel. In case the overload start message 1200 has already been sent for the fallback cell 312 associated with the failed sensitive cell 310, the CN 702 (e.g., the MME or AMF 200) sends a cell-specific overload stop message 904 for the fallback cell 312, e.g., to the fallback NE 300 serving the fallback cell 312, according to the steps 504 and 620. Furthermore, the fallback cell 312 associated with the failed sensitive cell 310 receives a backup configuration including the control command and/or transmission parameters for covering the failed cell 310. The backup configuration may be sent by the OSS according to the step 404 or may be automatically adjusted, e.g. via a self-organizing network (SON) procedure, in order to cover the area of the sensitive cell 310 that failed.

An advantage of the second embodiment is illustrated by the following comparative example for a conventional overload function. Conventionally, no action is taken by a congested CN in case an important site of the RAN goes into outage. Suppose that during a congestion (i.e., overloaded state) of a conventional MME, one RAN node, say eNB₁, that did not receive an overload start message because it is covering an important area, goes into outage due to any software or hardware issue. Suppose that the surrounding sites, say eNB₂ and eNB₃, had already received overload start messages during that same period of the overloaded state at the MME. As a result, the important site eNB₁ and its surrounding sites eNB₂ provide no radio access for the important area.

In contrast, the second embodiment allows to unbar a surrounding site as the fallback cell 312, e.g. by the MME or AMF 200 sending a cell-specific overload stop message 904 to the eNB₂ 300, in order to cover the geographical area 310 of eNB₁ 300.

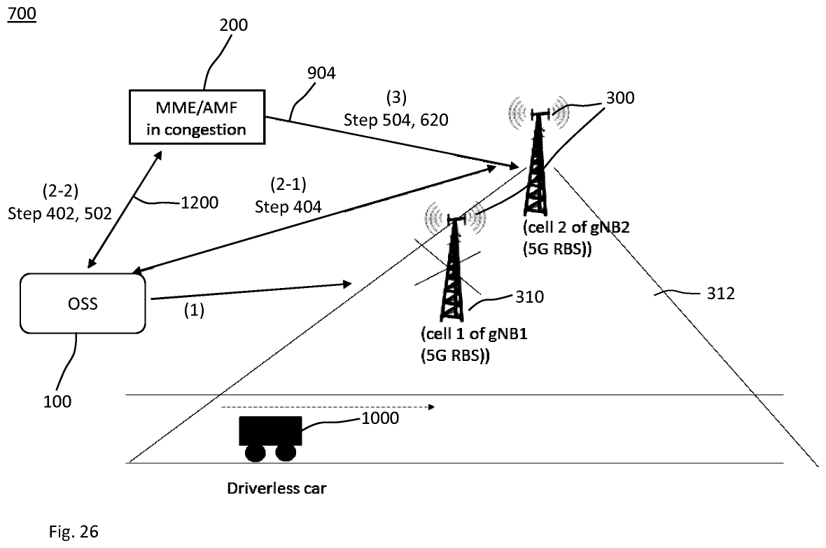

An implementation of the second embodiment is described with reference to FIG. 26. When a sensitive cell fails (1), an overload stop message 904 is sent to the associated fallback cell 312 (also: standby cell) according to the step 504 and 620. As a prerequisite, for each sensitive cell 310, the OSS 100 (e.g., due to a configuration by an operator or based on the reports stored in the database 2200) associates a fallback cell 310. The fallback cell 310 may belong to NE 300 serving the sensitive cell 310 or to another NE 300. The latter case is illustrated in FIG. 26. The role of the associated fallback cell 312 is to take over the coverage in the area of the failed sensitive cell 310. The takeover may be implemented using existing SON features, e.g. by up or down tilting of an antenna and/or increasing or decreasing the power of the fallback cell 312.

For example, the transmission control module 104 or a dedicated entity is implemented at the OSS 100 and configured to perform at least one of the following actions. Each time any sensitive cell 310 fails, the fallback cell 312 is triggered (2-1) to take over and cover the area of the failed cell 310 according to the step 404. The configuration message 1200 is sent (2-2) to the CN 702, e.g., to the MME or AMF 200, according to the steps 402 and 502 in order to trigger sending (3) an overload stop message 904 for the fallback cell 312 to the fallback NE 300 according to the steps 504 and 620, in case the fallback NE 300 has previously received an overload start message 902.

In any embodiment, the overload messages 902 and/or 904 may be cell-specific by referring to one or more specific cells or the action triggered by the overload messages 902 and/or 904 may be cell-specific based on the configuration message 1200. Particularly, the first embodiment may be implemented by sending an overload start message 902 on a cell basis. Similarly, the second embodiment may be implemented by sending an overload stop message 904 on a cell basis. The embodiments are combinable. For example, when the overload start message 902 is sent to trigger the overload function for a cell₁ of an NE₁, the overload stop message 904 is sent later for that same cell₁ of the NE₁.

A deployment option for any embodiment, particularly for an LTE (or 4G) or an NR (or 5G) implementation of the cellular network 700, serves the one or more sensitive cells 310, 312 in an overloaded state 908 at the CN 702 by setting aside dedicated resources, e.g., slice resources, of the CN 702 to serve such sensitive cells 310, 312.

3GPP standards for 5G implementations of the cellular network 700 comprise restricted areas. I.e., the network 700 assigns specific restrictions individually per mobile device 1000 (e.g., per UE). The technique may beneficially be combined with such implementations, e.g., since the restricted areas enforce restriction at a normal or regular operation of the cells. The subject technique may be implemented to restrict services in an abnormal condition, namely the overloaded state 908, in which state it is not possible to perform reliable signaling to adjust a restricted area for registered UEs 1000. For example, restricted areas may only be used with static and/or persistent UE restrictions.

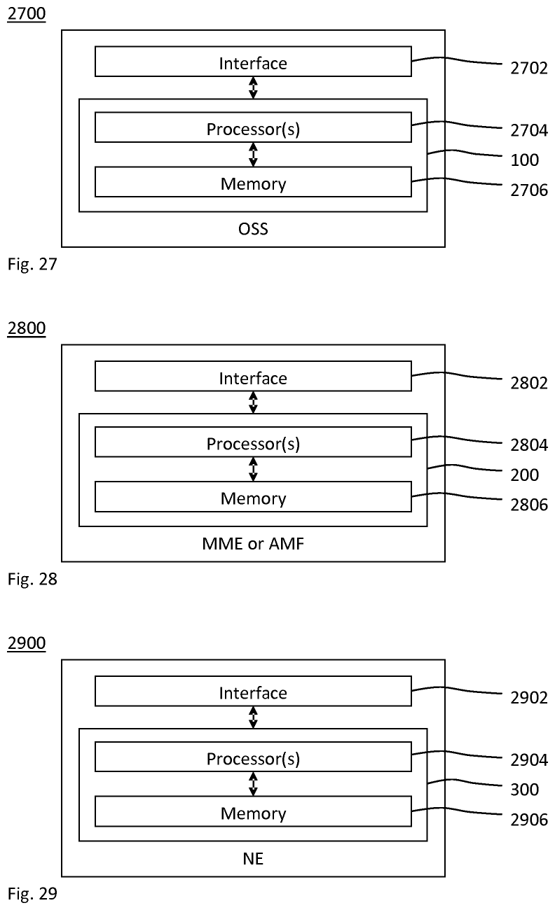

FIG. 27 shows a schematic block diagram for an embodiment of the device 100. The device 100 comprises one or more processors 2704 for performing the method 400 and memory 2706 coupled to the processors 2704. For example, the memory 2706 may be encoded with instructions that implement at least one of the modules 102 and 104.

The one or more processors 2704 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 2706, operations control functionality and/or system manager functionality. For example, the one or more processors 2704 may execute instructions stored in the memory 2706. Such functionality may include providing various features and steps discussed herein, including any of the benefits disclosed herein. The expression “the device being operative to perform an action” may denote the device 100 being configured to perform the action.

As schematically illustrated in FIG. 27, the device 100 may be embodied by an OSS 2700, e.g., functioning as a domain manager. The OSS 2700 comprises an interface 2702 coupled to the device 100 for data and control communication with nodes of a core network and/or nodes of a radio access network.

FIG. 28 shows a schematic block diagram for an embodiment of the device 200. The device 200 comprises one or more processors 2804 for performing the method 500 and memory 2806 coupled to the processors 2804. For example, the memory 2806 may be encoded with instructions that implement at least one of the modules 202 and 204.

The one or more processors 2804 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 200, such as the memory 2806, mobility functionality and/or core network functionality. For example, the one or more processors 2804 may execute instructions stored in the memory 2806. Such functionality may include providing various features and steps discussed herein, including any of the benefits disclosed herein. The expression “the device being operative to perform an action” may denote the device 200 being configured to perform the action.

As schematically illustrated in FIG. 28, the device 200 may be embodied by an MME or AMF 2800. The MME or AMF 2800 comprises an interface 2802 coupled to the device 200 for data and control communication with an OSS and/or nodes of a radio access network.

FIG. 29 shows a schematic block diagram for an embodiment of the device 300. The device 300 comprises one or more processors 2904 for performing the method 600 and memory 2906 coupled to the processors 2904. For example, the memory 2906 may be encoded with instructions that implement at least one of the modules 302 and 304.

The one or more processors 2904 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 300, such as the memory 2906, radio access functionality and/or base station functionality. For example, the one or more processors 2904 may execute instructions stored in the memory 2906. Such functionality may include providing various features and steps discussed herein, including any of the benefits disclosed herein. The expression “the device being operative to perform an action” may denote the device 300 being configured to perform the action.

As schematically illustrated in FIG. 29, the device 300 may be embodied by an NE 2900. The NE 2900 comprises an interface 2902 coupled to the device 300 for data and control communication with an OSS and/or nodes of a core network.

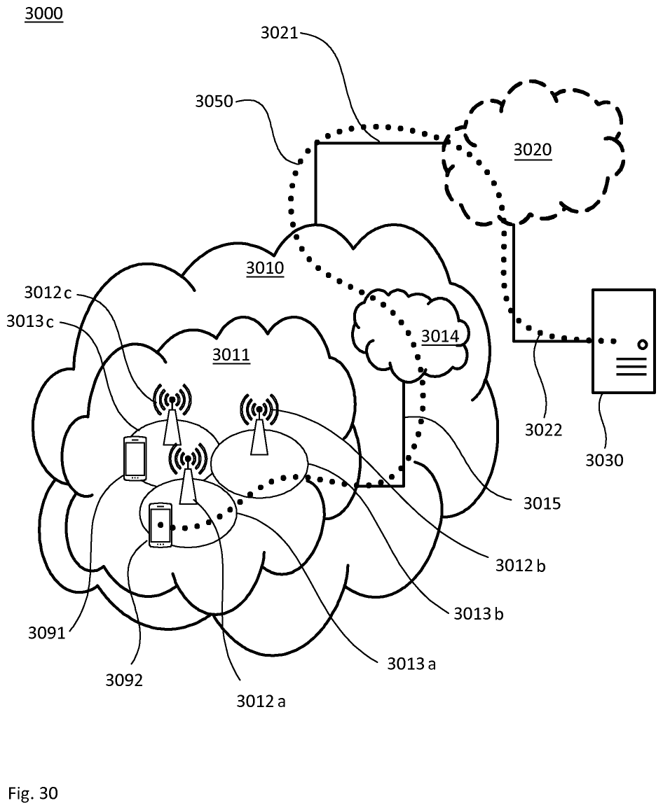

With reference to FIG. 30, in accordance with an embodiment, a communication system 3000 includes a telecommunication network 3010, such as a 3GPP-type cellular network, which comprises an access network 3011, such as a radio access network, and a core network 3014. The access network 3011 comprises a plurality of base stations 3012a, 3012b, 3012c, such as NBs, eNBs, gNBs or other types of wireless access points, each defining a corresponding coverage area 3013a, 3013b, 3013c. Each base station 3012a, 3012b, 3012c is connectable to the core network 3014 over a wired or wireless connection 3015. A first user equipment (UE) 3091 located in coverage area 3013c is configured to wirelessly connect to, or be paged by, the corresponding base station 3012c. A second UE 3092 in coverage area 3013a is wirelessly connectable to the corresponding base station 3012a. While a plurality of UEs 3091, 3092 are illustrated in this example, the disclosed embodiments are equally applicable to a situation where a sole UE is in the coverage area or where a sole UE is connecting to the corresponding base station 3012.

The telecommunication network 3010 is itself connected to a host computer 3030, which may be embodied in the hardware and/or software of a standalone server, a cloud-implemented server, a distributed server or as processing resources in a server farm. The host computer 3030 may be under the ownership or control of a service provider, or may be operated by the service provider or on behalf of the service provider. The connections 3021, 3022 between the telecommunication network 3010 and the host computer 3030 may extend directly from the core network 3014 to the host computer 3030 or may go via an optional intermediate network 3020. The intermediate network 3020 may be one of, or a combination of more than one of, a public, private or hosted network; the intermediate network 3020, if any, may be a backbone network or the Internet; in particular, the intermediate network 3020 may comprise two or more sub-networks (not shown).

The communication system 3000 of FIG. 30 as a whole enables connectivity between one of the connected UEs 3091, 3092 and the host computer 3030. The connectivity may be described as an over-the-top (OTT) connection 3050. The host computer 3030 and the connected UEs 3091, 3092 are configured to communicate data and/or signaling via the OTT connection 3050, using the access network 3011, the core network 3014, any intermediate network 3020 and possible further infrastructure (not shown) as intermediaries. The OTT connection 3050 may be transparent in the sense that the participating communication devices through which the OTT connection 3050 passes are unaware of routing of uplink and downlink communications. For example, a base station 3012 may not or need not be informed about the past routing of an incoming downlink communication with data originating from a host computer 3030 to be forwarded (e.g., handed over) to a connected UE 3091. Similarly, the base station 3012 need not be aware of the future routing of an outgoing uplink communication originating from the UE 3091 towards the host computer 3030.

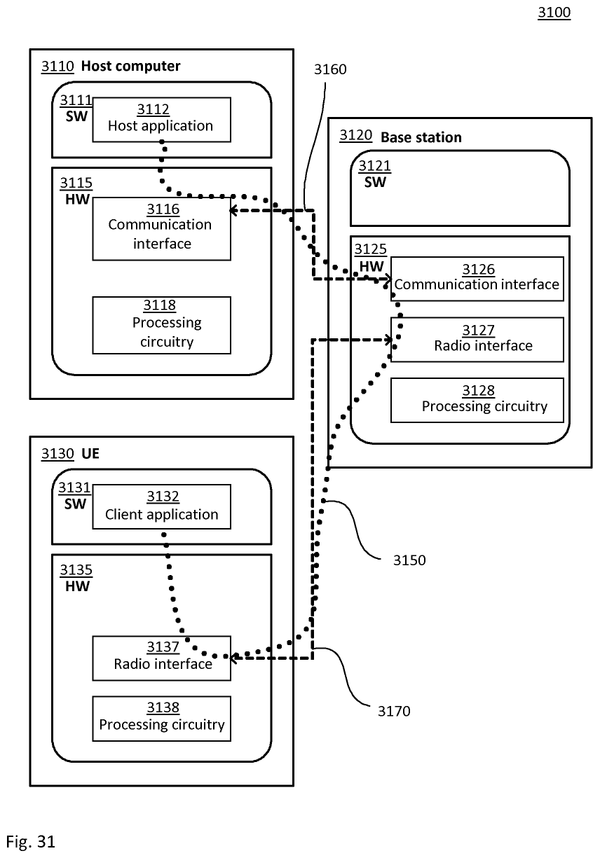

Example implementations, in accordance with an embodiment, of the UE, base station and host computer discussed in the preceding paragraphs will now be described with reference to FIG. 31. In a communication system 3100, a host computer 3110 comprises hardware 3115 including a communication interface 3116 configured to set up and maintain a wired or wireless connection with an interface of a different communication device of the communication system 3100. The host computer 3110 further comprises processing circuitry 3118, which may have storage and/or processing capabilities. In particular, the processing circuitry 3118 may comprise one or more programmable processors, application-specific integrated circuits, field programmable gate arrays or combinations of these (not shown) adapted to execute instructions. The host computer 3110 further comprises software 3111, which is stored in or accessible by the host computer 3110 and executable by the processing circuitry 3118. The software 3111 includes a host application 3112. The host application 3112 may be operable to provide a service to a remote user, such as a UE 3130 connecting via an OTT connection 3150 terminating at the UE 3130 and the host computer 3110. In providing the service to the remote user, the host application 3112 may provide user data, which is transmitted using the OTT connection 3150. The user data may depend on the location of the UE 3130. The user data may comprise auxiliary information (e.g., velocity and density of a road traffic flow for autonomous driving) or precision advertisements (also: ads) delivered to the UE 3130. The location may be reported by the UE 3130 to the host computer, e.g., using the OTT connection 3150, and/or by the base station 3120, e.g., using a connection 3160.

The communication system 3100 further includes a base station 3120 provided in a telecommunication system and comprising hardware 3125 enabling it to communicate with the host computer 3110 and with the UE 3130. The hardware 3125 may include a communication interface 3126 for setting up and maintaining a wired or wireless connection with an interface of a different communication device of the communication system 3100, as well as a radio interface 3127 for setting up and maintaining at least a wireless connection 3170 with a UE 3130 located in a coverage area (not shown in FIG. 31) served by the base station 3120. The communication interface 3126 may be configured to facilitate a connection 3160 to the host computer 3110. The connection 3160 may be direct or it may pass through a core network (not shown in FIG. 31) of the telecommunication system and/or through one or more intermediate networks outside the telecommunication system. In the embodiment shown, the hardware 3125 of the base station 3120 further includes processing circuitry 3128, which may comprise one or more programmable processors, application-specific integrated circuits, field programmable gate arrays or combinations of these (not shown) adapted to execute instructions. The base station 3120 further has software 3121 stored internally or accessible via an external connection.

The communication system 3100 further includes the UE 3130 already referred to. Its hardware 3135 may include a radio interface 3137 configured to set up and maintain a wireless connection 3170 with a base station serving a coverage area in which the UE 3130 is currently located. The hardware 3135 of the UE 3130 further includes processing circuitry 3138, which may comprise one or more programmable processors, application-specific integrated circuits, field programmable gate arrays or combinations of these (not shown) adapted to execute instructions. The UE 3130 further comprises software 3131, which is stored in or accessible by the UE 3130 and executable by the processing circuitry 3138. The software 3131 includes a client application 3132. The client application 3132 may be operable to provide a service to a human or non-human user via the UE 3130, with the support of the host computer 3110. In the host computer 3110, an executing host application 3112 may communicate with the executing client application 3132 via the OTT connection 3150 terminating at the UE 3130 and the host computer 3110. In providing the service to the user, the client application 3132 may receive request data from the host application 3112 and provide user data in response to the request data. The OTT connection 3150 may transfer both the request data and the user data. The client application 3132 may interact with the user to generate the user data that it provides.

It is noted that the host computer 3110, base station 3120 and UE 3130 illustrated in FIG. 31 may be identical to the host computer 3030, one of the base stations 3012a, 3012b, 3012c and one of the UEs 3091, 3092 of FIG. 30, respectively. This is to say, the inner workings of these entities may be as shown in FIG. 31 and independently, the surrounding network topology may be that of FIG. 30.

In FIG. 31, the OTT connection 3150 has been drawn abstractly to illustrate the communication between the host computer 3110 and the use equipment 3130 via the base station 3120, without explicit reference to any intermediary devices and the precise routing of messages via these devices. Network infrastructure may determine the routing, which it may be configured to hide from the UE 3130 or from the service provider operating the host computer 3110, or both. While the OTT connection 3150 is active, the network infrastructure may further take decisions by which it dynamically changes the routing (e.g., on the basis of load balancing consideration or reconfiguration of the network).

The wireless connection 3170 between the UE 3130 and the base station 3120 is in accordance with the teachings of the embodiments described throughout this disclosure. One or more of the various embodiments improve the performance of OTT services provided to the UE 3130 using the OTT connection 3150, in which the wireless connection 3170 forms the last segment. More precisely, the teachings of these embodiments may reduce the latency and improve the data rate and thereby provide benefits such as better responsiveness.

A measurement procedure may be provided for the purpose of monitoring data rate, latency and other factors on which the one or more embodiments improve. There may further be an optional network functionality for reconfiguring the OTT connection 3150 between the host computer 3110 and UE 3130, in response to variations in the measurement results. The measurement procedure and/or the network functionality for reconfiguring the OTT connection 3150 may be implemented in the software 3111 of the host computer 3110 or in the software 3131 of the UE 3130, or both. In embodiments, sensors (not shown) may be deployed in or in association with communication devices through which the OTT connection 3150 passes; the sensors may participate in the measurement procedure by supplying values of the monitored quantities exemplified above, or supplying values of other physical quantities from which software 3111, 3131 may compute or estimate the monitored quantities. The reconfiguring of the OTT connection 3150 may include message format, retransmission settings, preferred routing etc.; the reconfiguring need not affect the base station 3120, and it may be unknown or imperceptible to the base station 3120. Such procedures and functionalities may be known and practiced in the art. In certain embodiments, measurements may involve proprietary UE signaling facilitating the host computer's 3110 measurements of throughput, propagation times, latency and the like. The measurements may be implemented in that the software 3111, 3131 causes messages to be transmitted, in particular empty or “dummy” messages, using the OTT connection 3150 while it monitors propagation times, errors etc.

FIG. 32 is a flowchart illustrating a method implemented in a communication system, in accordance with one embodiment. The communication system includes a host computer, a base station and a UE which may be those described with reference to FIGS. 30 and 31. For simplicity of the present disclosure, only drawing references to FIG. 32 will be included in this section. In a first step 3210 of the method, the host computer provides user data. In an optional substep 3211 of the first step 3210, the host computer provides the user data by executing a host application. In a second step 3220, the host computer initiates a transmission carrying the user data to the UE. In an optional third step 3230, the base station transmits to the UE the user data which was carried in the transmission that the host computer initiated, in accordance with the teachings of the embodiments described throughout this disclosure. In an optional fourth step 3240, the UE executes a client application associated with the host application executed by the host computer.

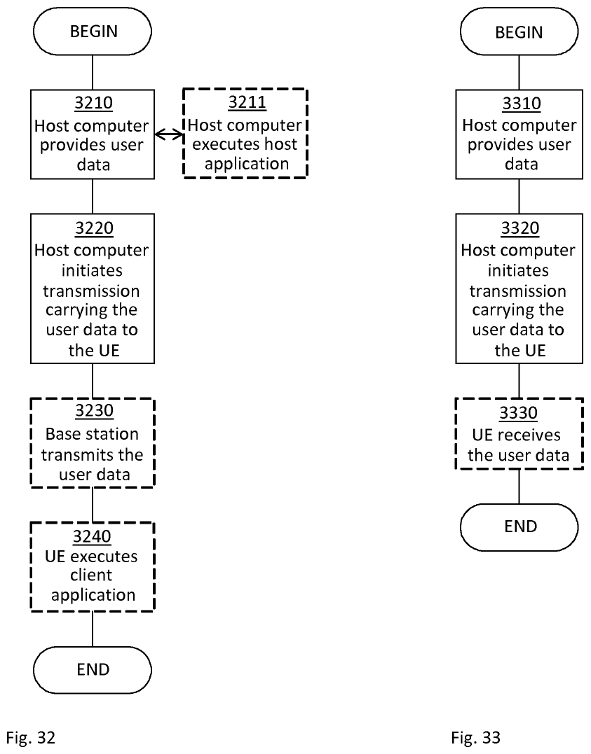

FIG. 33 is a flowchart illustrating a method implemented in a communication system, in accordance with one embodiment. The communication system includes a host computer, a base station and a UE which may be those described with reference to FIGS. 30 and 31. For simplicity of the present disclosure, only drawing references to FIG. 33 will be included in this section. In a first step 3310 of the method, the host computer provides user data. In an optional substep (not shown) the host computer provides the user data by executing a host application. In a second step 3320, the host computer initiates a transmission carrying the user data to the UE. The transmission may pass via the base station, in accordance with the teachings of the embodiments described throughout this disclosure. In an optional third step 3330, the UE receives the user data carried in the transmission.

As a result of embodiments of the technique, the user data and thus the underlying service provided by the host computer can run on a greater number of sensitive cells as compared to a conventional overload function. Optionally, the sensitive cells may be selected to comprise cells specifically relevant for providing the service of the host computer, such as services related to autonomous driving or connected driving.

With reference to the afore-mentioned example for connected driving, emergency services or autonomous driving, the regular capacity of a CN 702 with 600 NEs 300 serving 1800 cells has to be reduced to a maximum capacity of 600 operative cells for a congested CN 702, e.g. with the following scenario. Suppose that each NE 300 is configured to serve three cells, wherein cell₁ is covering a road for autonomously driving cars using the user data provided by the host computer, whereas cell₂ and cell₃ are used to cover a normal area, e.g., a non-sensitive cells 314.

In a conventional implementation of the overload function, the overload message is sent at a NE-basis, so that a remaining capacity of 600 cells served by 200 NEs would be comprise 200 cells (e.g., 200 instances of the cell₁) that are sensitive for the service of the host computer, but also 400 non-sensitive cells (i.e., cell₂ and cellₐ in the example).

The technique can be implemented so that the overload message is sent on a cell-basis. Consequently, embodiments of the technique can spare all 600 cells that are sensitive for the service of the host computer from applying the overload function.

As a consequence, during a period of congestion of the CN 702, the services provided by the host computer would be significantly reduces by a conventional overload function (e.g., to run only on 200 sensitive cells), whereas embodiments of the technique enable the host computer to continue to run on the (e.g., service-specific) sensitive cells, e.g., all 600 sensitive cells.

For example, the host computer is configured to provide user data pertinent for autonomous driving as an example of the service. This service can persist because the cells relevant for the service are spared from the effect of the overload function by virtue of an embodiment of the technique.

As has become apparent from above description, embodiments of the technique enable that a number of sensitive cells to be maintained (i.e., to be spared from the action of an overload function) during a core network congestion is multiple times greater compared to existing overload functions. A gain in the number of maintained sensitive cells may correspond to the (e.g., average) number of cells per site. E.g., the number of maintained sensitive cells may be multiplied by a factor of 3, for each site that has 3 cells, in comparison to existing overload functions. For example, the reliability of the radio access network can be significantly increased in certain areas.

Same or further embodiments can improve the reliability by associating and controlling a fallback cell for each sensitive cell. For each sensitive cell, cell₁, covering an important geographical area, area₁, a standby cell, cell₂, may be configured. Later, if the sensitive cell₁ goes down, the cellular network can automatically readjust, e.g., via Self Organization Network features, so that the fallback cell₂ covers area₁. Alternatively or in addition, the core network (e.g., the MME or AMF) may send a message (e.g., an overload stop message) to unbar the fallback cell₂ in case the fallback cell₂ was previously barred by the core network via an overload start message.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following claims.

1. A method of configuring an overload function in a cellular network comprising a core network (CN) and a radio access network (RAN) the overload function reducing a signaling load from the RAN towards the CN, wherein the RAN comprises at least one network element (NE) each serving at least two cells of the RAN, the method comprising:
sending a configuration message to the cellular network, the configuration message being indicative of at least one of the at least two cells, which is excluded from the overload function.

2. The method of claim 1, wherein the configuration message is indicative of less than the at least two cells as being excluded from the overload function.

3. The method of claim 1, wherein the overload function depends on an overload status of the CN of the cellular network.

4. The method of claim 3, wherein the overload function reduces the signaling load from the RAN towards the CN by restricting a service of the RAN in case the overload status of the CN comprises an overloaded state.

5. The method of claim 3, wherein the overload function comprises one or more overload messages that are sent from the CN to the at least one NE and imply or indicate the overload status of the CN.

6. The method of claim 5, wherein the overload messages comprise an overload start message that at least one of:
implies or is indicative of the overloaded state in the overload status; and
triggers the restriction of the service of the RAN.

7. The method of claim 5, wherein the overload messages comprise an overload stop message that at least one of:
implies or is indicative of a regular state in the overload status; and
releases the restriction of the service of the RAN.

8. The method of claim 5, wherein the configuration message is sent to each of the at least one NE and excludes the at least one indicated cell of the corresponding NE from the restriction.

9. The method of claim 8, wherein the configuration message causes the at least one NE to ignore the overload message with respect to the at least one indicated cell or wherein the configuration message induces a tag at the at least one for the at least one indicated cell.

10. (canceled)

11. The method of claim 5, wherein the CN comprises at least one of a Mobility Management Entity, MME, and an Access and Mobility Function, AMF and wherein at least one of:
the configuration message is sent to the at least one NE within a tracking area of the at least one of the MME and the AMF;
the overload status relates to the at least one of the MME and the AMF; and
the overload message is sent from the at least one of the MME and the AMF.

12. The method of claim 5, wherein the configuration message is sent to the CN, and wherein the one or more overload messages are cell-specific according to the at least one cell indicated in the configuration message.

13. The method of claim 12, wherein the overload message comprises an overload start message that is specific for at least one cell not indicated in the configuration message, and/or wherein the overload message comprises an overload stop message that is specific for at least one cell indicated in the configuration message.

14. The method of claim 5, wherein the CN comprises at least one of a Mobility Management Entity, MME, and an Access and Mobility Function, AMF, and wherein at least one of:
the configuration message is sent to at least one of the MME and the AMF;
the overload status relates to at least one of the MME and the AMF; and
the cell-specific overload message is sent from at least one of the MME and the AMF.

15. The method of claim 1, wherein the at least one NE comprises a fallback NE and the at least one excluded cell comprises a fallback cell of the fallback NE for a sensitive cell of a sensitive NE of the RAN, the fallback NE being configured to cover the sensitive cell if the sensitive NE fails.

16. The method of claim 15, further comprising:
determining a failure of the sensitive NE, wherein the configuration message or a further control message comprise a control command that controls the fallback cell to cover the sensitive cell.

17. The method of claim 1, wherein the configuration message is sent from or via an Operations and Support System (OSS).

18. The method of claim 1, wherein at least one of the sensitive cells, the excluded cells and the fallback cells are stored in a database, which is updated based on reports from mobile devices wirelessly connected to the RAN, and wherein the configuration message is sent from the database or derived from the database.

19-31. (canceled)

32. A device for configuring an overload function in a cellular network comprising a core network (CN) and a radio access network (RAN) the overload function reducing a signaling load from the RAN towards the CN, wherein the RAN comprises at least one network element (NE) each serving at least two cells of the RAN, the device comprising at least one processor and a memory, said memory comprising instructions executable by said at least one processor, whereby the device is operative to:
send a configuration message to the cellular network, the configuration message being indicative of at least one of the at least two cells, which is excluded from the overload function.

33. (canceled)

34. A device for configuring an overload function, the device comprising at least one processor and a memory, said memory comprising instructions executable by said at least one processor, whereby the device is operative to:
receive a configuration message at a core network (CN) for configuring the overload function that reduces a signaling load towards the CN from a radio access network (RAN) wherein the RAN comprises at least one network element (NE) each serving at least two cells, the configuration message being indicative of at least one of the at least two cells, which is excluded from the overload function.

35. (canceled)

36. A device for configuring an overload function in a cellular network comprising a core network, CN, and a radio access network, RAN, the overload function reducing a signaling load from the RAN towards the CN, the device comprising at least one processor and a memory, said memory comprising instructions executable by said at least one processor, whereby the device is operative to:
receive a message at a network element, NE, of the RAN, which NE serves at least two cells, the message comprising at least one of a configuration message indicative of at least one of the at least two cells, which is excluded from the overload function, and an overload message, which is cell-specific for excluding at least one of the at least two cells from the overload function and implies or is indicative of an overload status at the CN.

37-46. (canceled)
